(19) United States
(12) Patent Application Publication
(10) Pub. No.: US 2002/0069096 A1
(43) Pub. Date: Jun. 6, 2002

(54) Method and system for supplier relationship management

(76) Inventors: Paul Lindoerfer, Milford, CT (US); Stuart Sawabini, New Canaan, CT (US)

Correspondence Address: George T. Marcou, KILPATRICK STOCKTON LLP, Suite 900, 607 14th Street, NW, Washington, DC, 20005, US

(21) Appl. No.: 09/885,931

(22) Filed: Jun. 22, 2001

Related U.S. Application Data
(60) Provisional application No. 60/213,324, filed on Jun. 22, 2000.
(60) Provisional application No. 60/250,507, filed on Dec. 4, 2000.

(51) Int. Cl. G06F 17/60

(52) U.S. Cl. 705/7

(57) ABSTRACT

Provided herein is a secure Internet electronic commerce solution for buyers/manufacturers (hereafter “manufacturers”) and their respective vendors/suppliers (hereafter “suppliers”). The embodiments of the present invention provide an inter-enterprise business application or supplier relationship management system (“SRMS”) including tools that allow trading partners to collaboratively manage and optimize the execution of the supply chain management process. Further, the embodiments of the present invention provide benefits to both the manufacturer and the manufacturer's suppliers. The manufacturer benefits from greater supply chain efficiency arising from more comprehensive, accurate, and timely information, and from the cost savings afforded by having more suppliers connected electronically. The suppliers benefit from having a simple and inexpensive method of connecting with their manufacturing customer and from business applications that aid them in understanding and managing their supply chain requirements.

### CROSS-REFERENCE TO RELATED APPLICATIONS

This application claims priority to and incorporates by reference in their entirety, provisional applications numbered 60/213,324 and 60/250,507, both entitled “Method and System for Supply Chain Management” filed Jun. 22, 2000, and Dec. 4, 2000, respectively.

### BACKGROUND OF THE INVENTION

1. Field of the Invention

The subject matter of the present invention generally involves supply chain management, i.e., the business relationship between manufacturers and suppliers. More particularly, the present invention involves the electronic management of the manufacturer/supplier relationship including multiple manufacturers and their many suppliers.

2. Description of the Related Art

To date, manufacturers have spent considerable resources implementing electronic data interchange (‘EDI”) systems in order to manage their relationships with their suppliers. Unfortunately, manufacturers have been unable to convince many of their suppliers/customers to use these EDI systems, due to the perceived expense and complexity of implementation. The availability of the Internet to business users has enabled EDI data as well as non-EDI data to be exchanged between manufacturers and their suppliers in a simpler, less expensive and more widely available method. This, in turn, has enabled the development of Internet-based systems for managing the manufacturer/supplier business process. The current systems fall into two main categories: web-form systems and inter-enterprise supply chain management applications. Web-form systems provide users with on-line forms used to exchange data with trading partners. While these systems avoid printing and mailing costs, they do little to aid in the management of the trading relationship. Inter-enterprise supply chain management applications take the web-form systems a step further and attempt to offer value-added management services to users of these systems.

Consequently, there is a need in the art for an inter-enterprise supply chain management application that is easily and efficiently implemented and maintained by all users and which offers value-added services to all users.

### BRIEF SUMMARY OF THE INVENTION

In the embodiments of the present invention, there is provided a secure Internet electronic commerce solution for buyers/manufacturers (hereafter “manufacturers”) and their respective vendors/suppliers (hereafter “suppliers”). The embodiments of the present invention provide an inter-enterprise business application or supplier relationship management system (“SRMS”) including tools that allow trading partners to collaboratively manage and optimize the execution of the supply chain management process. Further, the embodiments of the present invention provide benefits to both the manufacturer and the manufacturer's suppliers. The manufacturer benefits from greater supply chain efficiency arising from more comprehensive, accurate, and timely information, and from the cost savings afforded by having more suppliers connected electronically. The suppliers benefit from having a simple and inexpensive method of connecting with their manufacturing customer and from business applications that aid them in understanding and managing their supply chain requirements.

Embodiments of the present invention provide manufacturers with a “drop-in” extension to the manufacturers existing EDI infrastructure.

Embodiments of the present invention provide suppliers with an easy-to-implement, low cost process for conforming to a manufacturer's EDI requirements, without having to purchase and learn how to use EDI software.

Embodiments of the present invention provide manufacturers and suppliers with the above capabilities when the data exchange is in non-EDI data format as well as EDI format. These other data formatting systems include XML formatted data as well as other proprietary methods.

Embodiments of the present invention provide real-time windows into the operation and status of the entire material supply process. This allows users, e.g., buyer/planners, schedulers, expediters, suppliers etc. . . . , to quickly see supply chain problems and respond accordingly.

Embodiments of the present invention provide real-time alerts to appropriate users of the SRMS of variations in the flow of the supply chain, e.g., late material shipments.

In a further embodiment of the present invention, one or more manufacturers sends data describing material delivery requirements to a server. Suppliers then access the server machine to view and to respond to the multiple manufacturer's requirements via a normalized business method with a normalized view of multiple manufacturer data and business requirements. The manufacturer also accesses the server to view requirements, and to check suppliers' responses to the requirements. The method and system are able to send alert messages, e.g., via automatically created e-mail, to both a manufacturer and a supplier, based on configurable criteria.

In a further embodiment of the present invention, a server contains the SRMS programs that embody best business practices, customized to the specifications of at least one manufacturer. Requirements data is received from a manufacturer, the SRMS applies business logic to the data, and the resulting requirements are placed in a database management system (“DBMS”). The manufacturer requirements data may be received from many different manufacturer systems each with different data formats, data structures and data content. The SRMS normalizes (converts it to a standard data structure within the SRMS) this data as it applies it to the DBMS thus affording all users access to this data in a single data structure regardless of its original source.

In a further embodiment of the present invention, the SRMS programs use the data in the DBMS to produce views into the supply chain process in the form of Web pages, so that a manufacturer, a supplier, and/or an administrator can use a standard browser, e.g., Internet Explorer, Netscape Navigator, at their respective locations to view the requirements, and in the case of a supplier, to respond to the requirements. The SRMS also allows a manufacturer or a supplier to download or upload files in various formats, e.g., EDI, XML, HTML, etc. The SRMS creates these files with normalized data structures so that the user receives the data in a consistent data structure regardless of the data source. For example, a purchase order from one manufacturer may have a different data content and data structure from a purchase order from another manufacturer. The SRMS representation of these purchase orders will have the same data structure thus providing the supplier with a single integration path and effort for both manufacturer's data verses two different paths and resultant increased efforts.

In a further embodiment of the present invention, the business practices that are enabled and enhanced include, but are not limited to: material planning schedule transmission, purchase order and purchase order change management, authorization to ship, availability to ship, information hierarchies, inventory stock status, material receipt, performance metric on shipments, remittance, request for quotation and quote, purchase order, schedule commit, ship notice preparation and processing, invoice preparation and processing, static document acquisition indexing and display, and trend analysis.

In a further embodiment of the present invention, there is a system for normalizing at least one output data structure comprising: a first server for receiving supply chain data in multiple data structures from multiple users; a first application for extracting supply chain data from the multiple data structures; a database for storing supply chain data in data fields within the database, wherein the supply chain data within the data fields is configurable by each of the multiple users according to the supply chain requirements of each of the multiple users; a second server for retrieving, from the database, supply chain data from at least one of the data fields upon request from a requester, wherein the requester is selected from the group consisting of at least one of the multiple users and at least one other user; a second application for formatting the requested supply chain data into at least one output data structure; a device for providing the requested supply chain data in the at least one output data structure, wherein the at least one output data structure is the same independent of the requester, such that the at least one output data structure is normalized.

In a further embodiment of the present invention, provided there is a process for normalizing at least one output data structure comprising: receiving supply chain data in multiple data structures from multiple users, wherein each of the multiple data structures is unique to one of the multiple users; extracting the supply chain data from each of the multiple data structures;

comparing the extracted supply chain data to data fields within a database, wherein the supply chain data is configurable by each of the multiple users according to the supply chain requirements of each of the multiple users; storing the extracted supply chain data in a matching data field within the database; retrieving the extracted supply chain data from the matching data field, within the database, in response to a request to view the extracted supply chain data made by a requester, wherein the requester is selected from the group consisting of at least one of the multiple users and at least one other user; and providing the extracted supply chain data in at least one output data structure, wherein the at least one output data structure is the same regardless of the identity of the requester, such that the at least one output data structure is normalized for all requesters.

### BRIEF DESCRIPTION OF THE DRAWINGS

In the Drawings:

FIG. 1 is a supply chain management system according to an embodiment of the present invention;

FIG. 2 is a supply chain management system according to an embodiment of the present invention;

FIG. 3 is data flow diagram according to an embodiment of the present invention;

FIG. 4 is a “User Profile” screen according to an embodiment of the present invention;

FIG. 5 is a “User Information Summary” screen according to an embodiment of the present invention;

FIG. 6 is a “Password Administration” screen according to an embodiment of the present invention;

FIG. 7 is a “Parts Information Summary” screen according to an embodiment of the present invention;

FIG. 8 is a “Parts Information-Detail” screen according to an embodiment of the present invention;

FIG. 9 is a “Ship-To Plant Codes” screen according to an embodiment of the present invention;

FIG. 10 is a “Carrier Information Summary” screen according to an embodiment of the present invention;

FIG. 11 is a “System Usage Report” screen according to an embodiment of the present invention;

FIG. 12 is a “System Parameter Maintenance” screen according to an embodiment of the present invention;

FIG. 13 is a “System Audit Report” screen according to an embodiment of the present invention;

FIG. 14 is a “Inventory Summary” screen according to an embodiment of the present invention;

FIG. 15 is a “Request for Quotation” screen according to an embodiment of the present invention;

FIG. 16 is a “RFQ Quote” screen according to an embodiment of the present invention;

FIG. 17 is a “RFQ Summary” screen according to an embodiment of the present invention;

FIG. 18 is a “Schedule Summary” screen according to an embodiment of the present invention;

FIG. 19 is a “Schedule Item Detail” screen according to an embodiment of the present invention;

FIG. 20 is a “Bills of Sourcing Hierarchy” screen according to an embodiment of the present invention;

FIG. 21 is a “Buffer Zone Actuals Valid” screen according to an embodiment of the present invention;

FIGS. 22(a) and 22(b) are flowcharts of a planning schedule process according to an embodiment of the present invention;

FIG. 23 is a “Schedule Commit” screen according to an embodiment of the present invention;

FIG. 24 is a flowchart for forming a commit schedule according to an embodiment of the present invention;

FIG. 25 is a “Schedule Commit Summary” screen according to an embodiment of the present invention;

FIG. 26 is a “Purchase Order” screen according to an embodiment of the present invention;

FIG. 27 is a purchase order process flow according to an embodiment of the present invention;

FIG. 28 is a “Purchase Order Summary” screen according to an embodiment of the present invention;

FIG. 29 is a “Available to Ship” screen according to an embodiment of the present invention;

FIG. 30 is a “Available to Ship Summary” screen according to an embodiment of the present invention;

FIG. 31 is a “Material Release” screen according to an embodiment of the present invention;

FIG. 32 is a “Material Release Summary” screen according to an embodiment of the present invention;

FIG. 33 is a “Authorization to Ship” screen according to an embodiment of the present invention;

FIG. 34 is a “Authorization to Ship Summary” screen according to an embodiment of the present invention;

FIG. 35 is a “Advance Ship Notice-PKG” screen according to an embodiment of the present invention;

FIG. 36 is a “Advance Ship Notice” screen according to an embodiment of the present invention;

FIG. 37 is a barcode generation list according to an embodiment of the present invention;

FIG. 38 is a “Ship Notice Summary” screen according to an embodiment of the present invention;

FIG. 39 is a materials shipping process according to an embodiment of the present invention;

FIG. 40 is a “Material Receipt Summary” screen according to an embodiment of the present invention;

FIG. 41 is a “Supplier Routing Instructions” screen according to an embodiment of the present invention;

FIG. 42 is a “Location Codes” screen according to an embodiment of the present invention;

FIG. 43 is a “Certification Remarks Summary” screen according to an embodiment of the present invention;

FIGS. 44(a) and 44(b) are “Payment Detail” screens according to an embodiment of the present invention;

FIG. 45 is a “Payment Summary” screen according to an embodiment of the present invention;

FIG. 46 is a “Invoice Summary” screen according to an embodiment of the present invention;

FIG. 47 is a “Commercial Invoice-Input Detail” screen according to an embodiment of the present invention;

FIG. 48 is a “Commercial Invoice Summary” screen according to an embodiment of the present invention;

FIG. 49 is a “Shipment Performance Summary” screen according to an embodiment of the present invention;

FIGS. 50(a) and 50(b) are “Quality Performance Summary” screens according to an embodiment of the present invention;

FIGS. 51(a) and 51(b) are “Report of Non-Conforming Material” screens according to an embodiment of the present invention;

FIG. 52 is a “Trend Anaylsis” screen according to an embodiment of the present invention;

FIG. 53 is a “System Parameters Maintenance” screen according to an embodiment of the present invention;

FIG. 54 is a “Compound Account Maintenance” screen according to an embodiment of the present invention;

FIG. 55 is an information hierarchy according to an embodiment of the present invention;

FIG. 56 is an e-mail configuration table according to an embodiment of the present invention;

FIG. 57 is an e-mail configuration table according to an embodiment of the present invention;

FIG. 58 is an e-mail configuration table according to an embodiment of the present invention;

FIG. 59 is a “Cumulative Reconciliation” screen according to an embodiment of the present invention;

FIG. 60 is a “Supplier Workbench” screen according to an embodiment of the present invention;

FIG. 61 is a “Buyer Workbench” screen according to an embodiment of the present invention;

FIG. 62 is a “Static Page Display Configuration” screen according to an embodiment of the present invention; and

FIG. 63 is a “Administration Menu” screen according to an embodiment of the present invention.

### DETAILED DESCRIPTION OF THE PREFERRED EMBODIMENTS

As is discussed further below, the SRMS may be hosted by a third party to the supply chain, e.g., a service provider, or the SRMS may be hosted by a party to the supply chain, e.g., the manufacturer. Regardless of who the hosting entity is, the method and system of the present invention may be practiced in full under either embodiment.

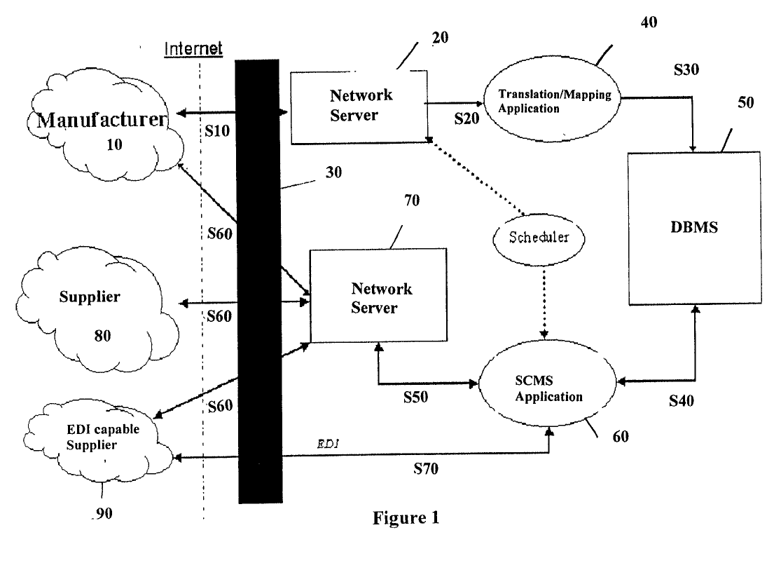

Referring to FIG. 1, in a first preferred but non-limiting embodiment of the present invention the SRMS is hosted by a third party service. Initial information/data (e.g., planning, parts, etc. . . . ) is provided via an established data link over a network (e.g., Internet) between a manufacturer 10 and the SRMS S10 through an appropriate server (e.g., network server) 20. In this particular embodiment, the components of the SRMS are placed within the service provider's firewall 30. Alternatively, some of the components of the SRMS may be placed external to the service provider's firewall. The data link may be implemented, e.g., by encrypted file transfer protocol (“FTP”), by a Virtual Private Network (“VPN”), or the like. The information/data provided by the manufacturer to the service provider is received by the server 20 and passes through translating (e.g., customer EDI, XML, etc. . . . ) and/or mapping software 40 within the SRMS S20. The mapping software maps the information/data into the database management system (“DBMS”) 50 of the SRMS S30. Depending on the specifications/needs of the manufacturer, the information/data mapping is performed using either an off-the-shelf data mapping software tool (e.g., Mercator) or alternatively specifically developed mapping software.

The DBMS is further accessed by a supply chain management software (“SCMS”) server 60 which utilizes multiple applications in order to effectively manage the supply chain as between trading partners S40. The information from the DBMS 50 and the SCMS server 60 is accessible through a second network server 70, S50. Network server 70 contains applications/programs that allow the manufacturer, as well as other users, at a remote location to bring up a Web page in a browser, such as Netscape Navigator or the Internet Explorer, and to log into the SRMS using a secure ID and password S60. Interaction between the manufacturer, as well as other users, and the SRMS is held in confidence via a secure protocol such as secure hypertext transfer protocol (“HTTP(s)”). Users of the SRMS include, but are not limited to, manufacturer personnel 10, non-EDI capable supplier personnel 80, EDI capable supplier personnel 90 or an administrator of the SRMS (not shown). Users can cause the SRMS to extract data on demand from the DBMS 50, filter it per user requirements, and display the results as a Web page through a network server 70. Further, users can facilitate transactions through a Web page via the network server 70. For example, a non-EDI capable supplier can complete and send a ship notice to their log in ID and to the trading manufacturer through network server 70. An EDI capable supplier can facilitate transactions either through network server 70 or directly through the SCMS application 60 using pre-established EDI components S70. Similarly, an administrator can set up a new user ID in the SRMS either through the network server 70 or directly through the SCMS application 60. Further, users can enter their own information, such as their e-mail address in order to receive automatically generated alert messages.

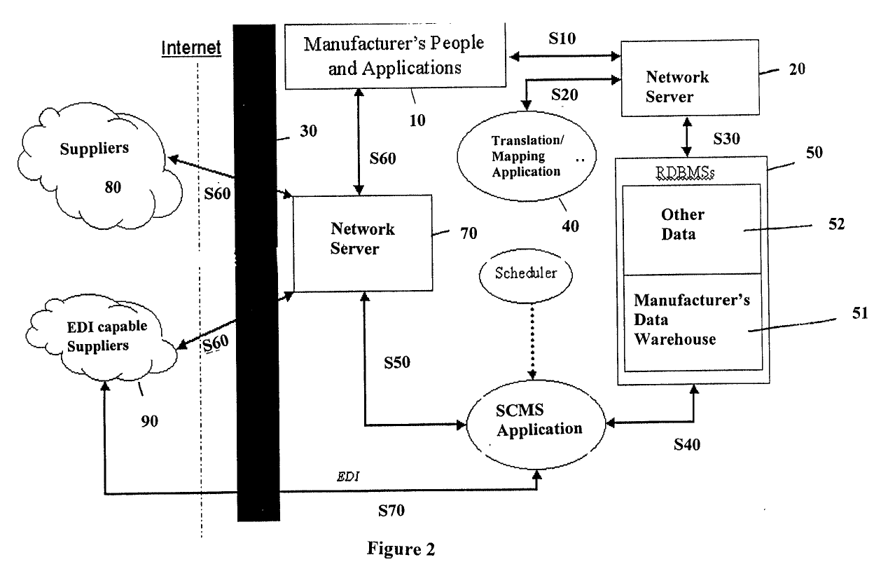

Referring to FIG. 2, in an alternative embodiment of the present invention, the SRMS is located within the manufacturer's firewall 30 as opposed to within the firewall of a service provider, i.e., the SRMS is hosted by the manufacturer as opposed to a service provider. In this alternative embodiment, the suppliers, EDI or non-EDI enabled, interact with the SRMS in the same way as described with reference to FIG. 1 utilizing essentially the same components. The manufacturer, as the host of the SRMS, need not enter supply chain requirements data/information through a firewall to network servers in this alternative embodiment. In FIG. 2, the manufacturer's supply chain requirements data/information can be retrieved from database 51, a database within the DBMS 50. Further, within the DBMS 50, there is at least one database 52 for storing variations of the manufacturer's data/information (e.g., after business practices applications have been applied), supplier information, and other relevant supply chain data tables. Further, manufacturer personnel may supplement the data/information from database 51 in real-time through a network server 20 as in FIG. 1, but without the need to go through a firewall or the Internet. As with the system and method of FIG. 1, the SCMS application 60, utilizes data/information from the DBMS 50 in order to effectively manage the supply chain as between trading partners.

In a preferred embodiment of the present invention, implementation of the core and connective functions of the SRMS are based on application design and database schema that are open and extensible. For example, the SRMS may implement scaleable components such as Checkpoint Firewall-I, Netscape's Enterprise Server, ECXpert with Mercator, and Oracle 8i. The SRMS application server is run on appropriate hardware e.g., Solaris or scaleable SUN machines. Further, the SRMS application software may be written in various formats, e.g., Java, Perl, Javascript, Unix shell scripts, and PL/SQL. One skilled in the art recognizes that design specifications may require the conversion of significant parts of the SRMS to a programming language such as Java, using additional Java-based technologies such as Enterprise Java Beans. Further, one skilled in the art recognizes the many component substitutes which are available to formulate the SRMS and the examples provided herein are not intending to be limiting.

As discussed further herein, in order to connect with the SRMS in certain embodiments of the present invention, a registered user (e.g., administrator, manufacturer personnel, and supplier personnel) will need a web browser such as Netscape Navigator or Internet Explorer run on a standard PC or similar processing/viewer device (e.g., personal digital assistant or the like) connected to the internet.

In the embodiments of the present invention set forth below, users of the SRMS download and upload a large amount of information, in multiple formats and multiple data structures. The SRMS is configured so as to facilitate data access via web browsers as well as two-way transfer of data files over the Internet in a variety of formats (e.g., EDI, XML). This configuration aids users in integrating supply chain data into their business applications and/or company databases. The SRMS requires the SRMS facility to export data (both documents and summary display data) in a variety of formats. In a preferred embodiment of the present invention, the initial download implementation was done in CSV (Comma Separated Value) format. The SRMS enables file data transfers to/from suppliers for application integration and allows for selection of format for download from multiple possibilities. Further, the embodiments of the present invention provide that the contents of these files be internally organized in a consistent (normalized) data structure for all similar data (e.g.; planning schedules, purchase orders) from one or more manufacturers.

Further, the SRMS provides users with data editing tools for downloaded data. For example, many suppliers do not want to take schedule data directly into their ERP/MRP system. Instead, users want the opportunity to utilize their experience with the manufacturer and knowledge of their own manufacturing processes to view and/or change the data prior to importing. In addition to data editing tools, the SRMS provides data mapping tools for integrating the SRMS data into user systems such as MRP or Order Entry. These tools may reside either on the user personal computer (“PC”) or similar processing tool or on the SRMS. Additional supporting software provided by the SRMS includes drawing and schematic applications, for viewing and downloading product engineering documents (e.g., CAD (“computer-aided design”)/CAM (“computer-aided manufacturing”) drawings. The ability to view drawing and schematic documents related to the products they provide or are proposing to provide is highly beneficial to the decision making processes of the users of the SRMS. For example, these applications allow suppliers to determine the engineering drawings associated with any product requirement and to download the required drawings via the Internet.

FIGS. 1 and 2 refer generally to the hardware and software components of an SRMS and the paths of information transfer according to the embodiments of the present invention. Discussed further below are alternative embodiments for more specific implementations of the SRMS components and the methods of access accorded to users of the SRMS of the present invention.

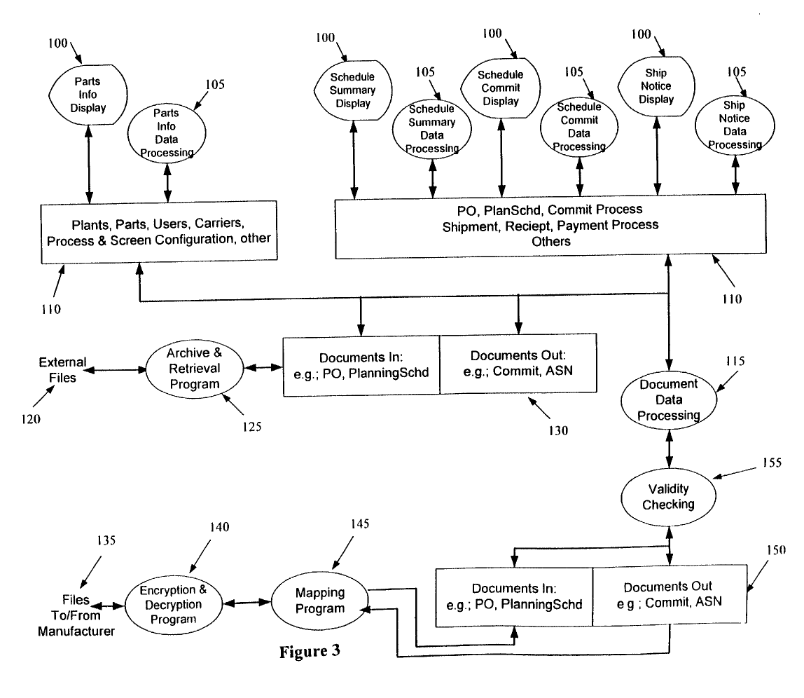

FIG. 3 shows some representative parts of the software architecture of the SRMS. Files of data received from the manufacturer are decrypted by an encryption/decryption program 140, passed through a mapping program 145 (e.g., Mercator) and stored in a set of holding tables 150 within the DBMS 50 of the SRMS. Prior to passing through to the data processor, the data in the holding tables 150 is validated by a validation and check program 155 and stored in the permanent document storage tables 130. Further processing of the data in the holding tables 150 and permanent document storage tables 130 causes summary and composite data derived from the this data to be merged into the operational tables 110. The merging process adds new data to the operational tables and causes selected existing data to be modified or changed according to business process rules applied in the process. Various display screens 100, e.g., Webpages, are available to SRMS users through appropriate Web browsers. These display screens 100 present the user with selected data from the operational tables 110 and permanent document storage tables 130 along with data generated by the screen data processing programs 105. Each screen data processing program 105 utilizes data contained in one or more configuration files to determine which data to present on the screen and the data structure of the data when presented. The examples shown include display screens for displaying and processing data regarding parts information, schedule summaries, schedule commits, and ship notices. In this particular example, the parts information display screens are configured to present information on manufacturer parts, for instance, the part number and the part description. Further to this example, the schedule summary display screen, commit display screen and the ship notice display screen are configured to display information from purchase orders, planning schedules, commit process shipments, receipts, payment processes, etc.

Information from the display screens 100 also moves in the opposite direction, such that information is entered at the screen level 100 and ends at the files sent to the manufacturer 135. Passing along the way through the various operational tables 110, the data processor 115, the permanent storage tables 130, the validation and check program 155, the holding tables 150, the mapping program 145, and the encryption program 140 before being transmitted electronically to the manufacturer.

The archive and retrieval program 125 retrieves data from various tables within the DBMS, creates files to hold the data and moves these external files 120 to a storage area external to the DBMS.

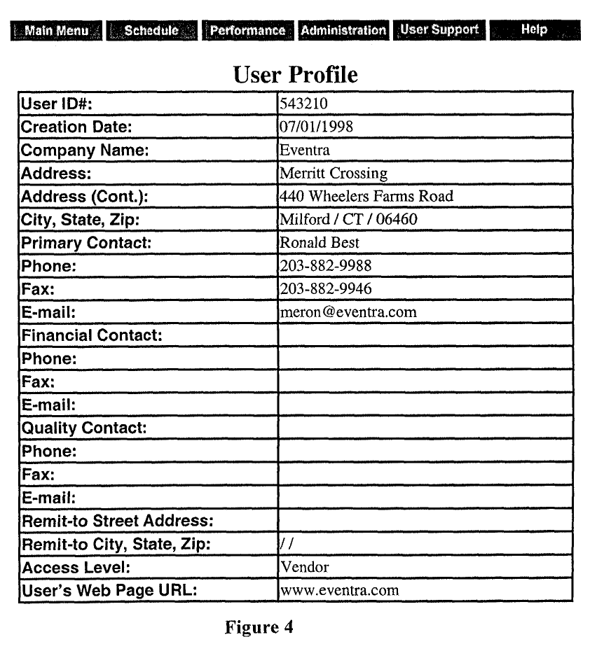

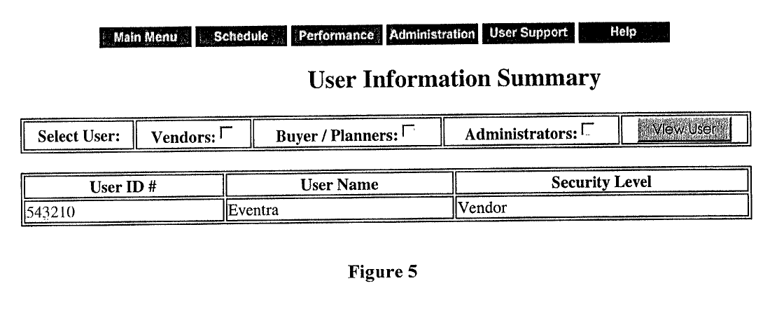

In a preferred embodiment of the present invention, in order to gain access to an SRMS, a supplier must register with the SRMS. In the embodiments wherein the supplier is already using an established EDI system, this registration may not be necessary. The method and system of the present invention are designed to be integrated with established EDI systems. The EDI-enabled suppliers need only take advantage of the value-added serviced provided through the EDI channels. For non-EDI enabled suppliers, or suppliers who wish to utilize an Internet-based SRMS (assuming the pre-established EDI system is not Internet-based), the registration process entails, at the very least, exchanging with the manufacturer (or alternatively a third-party service provider) supplier identification (“ID”) information for a user ID and a password. In alternative embodiments, the manufacturer or service provider may require additional information from the supplier (e.g., product and/or service information, performance history information, etc. . . . ). The SRMS provides a user (e.g., supplier/vendor) profile screen in order to gather data on SRMS users. Exemplified in FIG. 4, the “User Profile” screen prompts users for and displays the following types of information: an assigned user identification number (“user ID”), a creation date, company name, company address, primary contact information (e.g., phone, facsimile, e-mail address), financial contact information, quality contact information, remit-to address, access level (e.g., supplier/vendor, manufacturer/buyer, SRMS administrator), company/user URL. A summary of users according to e.g., user ID, user/company name, and/or access level is available through a “User Information Summary” screen, exemplified in FIG. 5.

Other users who may gain access to the SRMS are SRMS administrators. In the embodiment wherein the host of the SRMS is the manufacturer, this administrator may be a manufacturer employee. In the embodiment wherein the SRMS host is a third-party service provider, the administrator may be a non-trading user. In either case, the administrator has access privileges which are different from those given to manufacturer and supplier personnel. Further, in many embodiments of the present invention, the manufacturer personnel and the supplier personnel also have varying access privileges.

More particularly, the SRMS supports at least three levels of users, administrators, manufacturer personnel, and supplier personnel. The design of the SRMS is flexible and configurable. Consequently, further access levels of users may be added. A user at any level has all of the following privileges: (1) the user can search database(s) of documents by, e.g., keyword, document type, and/or date range; (2) the user can sort any documents viewed according to various criteria; (3) the user can send e-mail to the SRMS tech support, via user support button; (4) the user can access online help; and (5) the user can change his/her own password.

In a particular embodiment of the present invention wherein administration of the SRMS is overseen by a third-party service provider, the SRMS is configured so that at least one person at the third-party service provider has administrator privileges, and so does at least one person at the manufacturer. Other manufacturer personnel (e.g., buyers/planners) have their own set of privileges (discussed further below). Finally, personnel in the supplier organization have, in most respects, the smallest set of privileges, however, he or she can make certain transactions, such as sending a ship notice, or committing to a manufacturer's schedule, that manufacturer personnel and SRMS administrators cannot make.

In an alternative embodiment of the present invention wherein a manufacturer chooses to own and manage the SRMS, a third-party service provider is not necessary. In this alternative embodiment, there may be instances wherein the manufacturer does wish to have a third-party service contract, but only for rare problems. In this particular scenario, a limited number of third-party SRMS administrators are allowed access to the SRMS.

Flexible configuration of access and permissions to the SRMS is achieved using database tables stored in the DBMS that contain information about each user entity (e.g., SRMS administrator, manufacturer, supplier) that has access to the SRMS:

VS_COMPANY_INFO
DUNS_NO, TAX_ID, CONTACT_ID_SHIPPING,
CUSTOMER_ID, CUSTOMER_SUB_ID, . . .
VS_LOGIN_TABLE
ORGANIZATION, MASTER_ID, MANUFACTURER,
SECURE_LEVEL, . . .

Additionally, the SRMS maintains separately within the DBMS a table of MASTER_IDs and encrypted passwords. A user at a third-party service provider, a manufacturer or at a supplier, accesses the SRMS by navigating his/her Web browser to an appropriate SRMS universal resource locator (“URL”). The user is then prompted for his/her Company ID, User ID and/or password. This information is sent securely to the SRMS server, where it is used to set the SECURE_LEVEL (administrator, buyer-planner, or supplier) for subsequent interactions. Further interactions between the user and the SRMS server are via an appropriate protocol, e.g., HTTP(s).

As referred to above, different categories of users have different SRMS access privileges. For example, if the user is an administrator from a third-party service provider, the first Web page that the user sees upon correctly entering his/her User ID and password is the list of manufacturers for whom the SRMS service is being managed by the third-party service provider. The user selects the appropriate manufacturer from the list and is directed to a directory page for the SRMS established for that particular manufacturer. This embodiment assumes that the service provider manages SRMSs for multiple manufacturers. For all other users, only one instance of the SRMS is currently viewable, namely the instance associated with a particular manufacturer. An SRMS administrator can view information about any supplier to that selected manufacturer. The SRMS administrator has the same access privileges as manufacturer personnel (discussed further below). Further, the SRMS administrator can prepare transaction pages that are normally prepared by a supplier, with the caveat that the SRMS administrator cannot save or transmit these pages (discussed further below). This access is useful, for example, when a supplier wishes to talk on the phone with an administrator and ‘walk through’ the preparation of a transaction page. An SRMS administrator who accesses the SRMS instance for a particular manufacturer has the ability, inter alia, to look at or change any product information for that manufacturer, view a delivery performance summary for any supplier to that manufacturer, change the list of destination locations for shipped products, change user profiles and logins, change the group of suppliers that a buyer-planner can view, change anyone's password, change the SRMS welcome message for each manufacturer, and send an e-mail broadcast to the suppliers, to the manufacturer personnel, to the SRMS administrators, or to any combination of these.

Further, the administrator level is the only level in the SRMS that has the privilege of viewing a “System Usage Report” that shows a summary of the activities of each user, e.g., how many documents were sent, received in a specified time period, etc.

Manufacturer personnel (e.g., buyer/planners) for a particular manufacturer can view information about a group of suppliers to that particular manufacturer that an SRMS administrator has assigned to the manufacturer personnel. For example, the manufacturer personnel are able to view a delivery performance summary for any supplier assigned to the manufacturer personnel by an SRMS administrator. Manufacturer personnel have the same access privileges as a person in a supplier organization (see below). Similar to the SRMS administrator privileges, manufacturer personnel can prepare transaction pages that are normally prepared by a supplier, with the caveat that the manufacturer personnel cannot save or transmit these pages. This feature is useful, for example, when a supplier wishes to talk on the phone with manufacturer personnel in order to “walk through” the preparation of a transaction page. Manufacturer personnel may also access the SRMS to view manufacturer requirements, and to check suppliers' responses to the requirements. The method and system are able to send alert messages, e.g., via automatically created e-mail, to both a manufacturer and a supplier, based on configurable criteria. Manufacturer personnel cannot add or change information about products, unless the manufacturer personnel is an SRMS administrator. Product information changes are performed by an SRMS administrator or by means of communication, e.g., a data feed derived from the manufacturer's MRP or other internal systems.

Finally, supplier personnel may access the SRMS for one or more manufacturers with which they have been assigned access. Users at a supplier are limited to viewing only information about the supplier that is related to these particular manufacturers. Supplier personnel are able to view documents, such as ship notices, that were created, saved or transmitted by other supplier personnel. Supplier personnel can create a new login to the SRMS, but only a login associated with the supplier personnel's own organization, and only with supplier level privileges. Supplier personnel can create, save, and transmit ship notices and commitments to the manufacturer's schedule within the SRMS. Supplier personnel can change information in the supply personnel's own profile, except for the profile ID number, which is created by the manufacturer. Supplier personnel can direct e-mail to designated manufacturer personnel (e.g., buyer-planner) and SRMS administrators. Supplier personnel can upload and download information about the particulars of the manufacturer requirements (e.g., component parts, services). In a preferred embodiment, this requirement information is in comma separated value (CSV) format. CSV is compatible with Excel spreadsheets and with many other common application programs. Supplier personnel can also view a list of manufacturer's destination sites for shipments of components. Supplier personnel can view any information on the system about the supplier, including, but not limited to, schedules, purchase orders, remittances, material receipt notices (if applicable), shipment performance summary information, and a summary of trends in orders for products and/or services supplied by that supplier to the manufacturer. Further, the supplier personnel can also access a page of links to the Web sites of shipping companies, such as UPS and Federal Express, to allow the supplier personnel to track the progress of a shipment.

As discussed above, subject only to the listed exceptions and caveats, SRMS administrators and manufacturer personnel have all the access privileges of the supplier personnel.

In the preferred embodiments of the present invention, the supply chain starts with the evaluation of the needs of a manufacturer, the manufacturer provides the initial supply chain requirement information/data (“SC Data”) to the SRMS. This initial SC Data can include, but is not limited to, any and all types of product and/or service information/data, including but not limited to specification (e.g., size, weight, color), price range, country of origin, as well as information/data on quantity, time/shipment requirements, acceptable variation from requirements, etc. As discussed with reference to FIGS. 1 and 2, this initial SC Data may be provided to the SRMS through various on-line and off-line network servers, in a variety of formats and data structures. The SRMS is equipped with translators and mapping applications for reading and storing the initial SC Data in an SRMS manipulatable format and data structure within the SRMS DBMS.

Once the manufacturer's initial SC Data is received by the SRMS, the SCMS manipulates the initial SC Data according to the customized needs of the manufacturer. This customization may occur on a number of levels, depending on the desire of the manufacturer. For example, the customization may be manufacturer specific or it may be customized to the product-type as opposed to the individual manufacturer or it may be customized to the industry as opposed to the product-type or the individual manufacturer. The manipulated initial SC Data is stored in the DBMS. Further, the SRMS is programmed and the SC Data is formatted and stored in the DBMS so as to compose Web pages when a registered user enters the SRMS using a standard browser.

Other data entered into the SRMS and stored in the DBMS includes operational tables that support displays in which the data changes frequently, tables for configuration of the SRMS, tables for data such as part numbers and descriptions, that changes infrequently, tables for storage of data extracted from EDI or other documents received from a manufacturer, and tables for holding data received from and sent to a manufacturer (e.g., supplier profiles data, password and ID data, compound account data, and shipping codes for manufacturer receiving locations).

In a preferred embodiment of the present invention, the relational database design for the SRMS consists of multiple (e.g., 100's) primary tables and views, augmented by multiple auxiliary tables containing sequences e.g., Oracle sequences. In this preferred embodiment, the design of certain tables, or of a groups of tables, is related to a document type. Document types are standardized across supply chains, in order to improve the efficiency and compatibility of supplier and manufacturer systems. As discussed above, the SRMS is capable of processing information that is received either in a proprietary format, or in a more widely used format, such as EDI or XML. The SRMS maps information received into appropriate data fields within database tables of the DBMS 50. For example, when the SRMS receives planning schedule data from a manufacturer, the SRMS maps this data into multiple tables, such as, “master” table, “detail” table, “available to ship” table, “commit” table, and “commit history” table using a mapping application 30, such as Mercator. Unlike the standard planning schedule document which simply calls for certain numbers of items at certain times, these related SRMS tables allow for extended functionality, including preparing data for a master summary display, each line of which is supported by one or more detail lines, the supplier indicating when products called for in the plan are available to ship, the supplier partially or fully committing to the planned demand for products, and the supplier changing his commitment, and recording a history of the commitment changes.

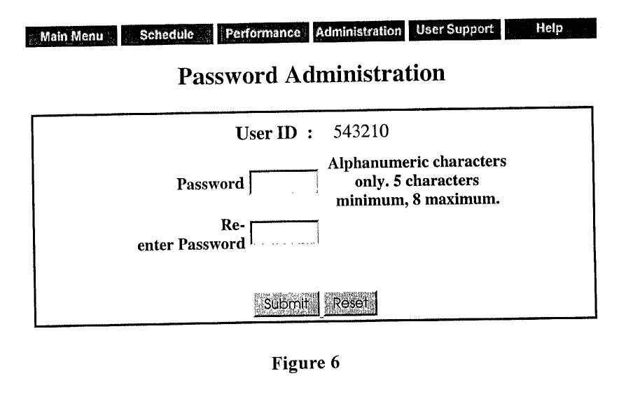

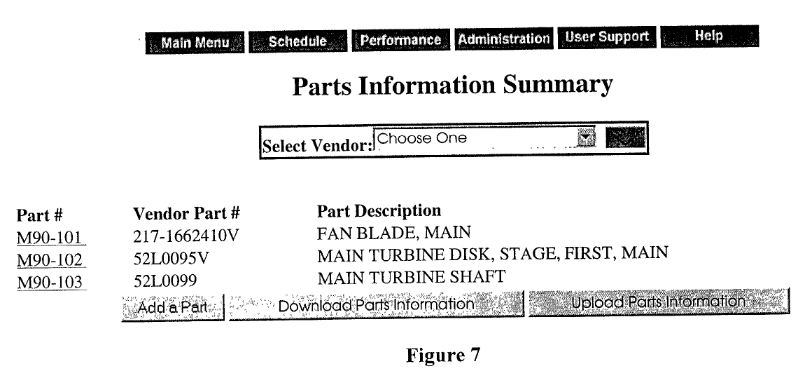

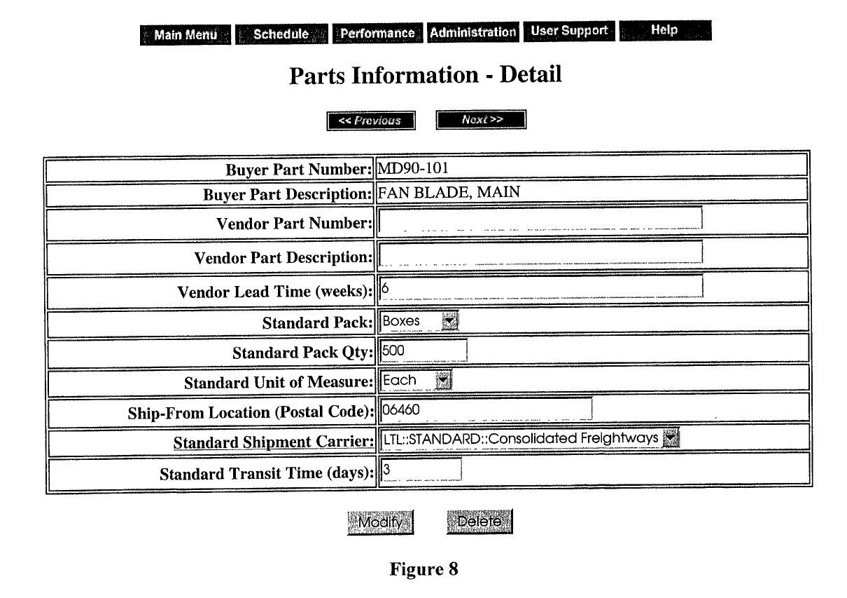

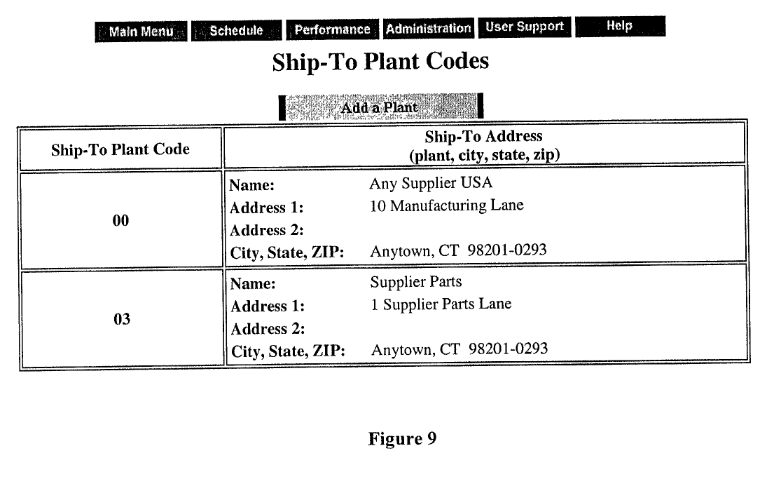

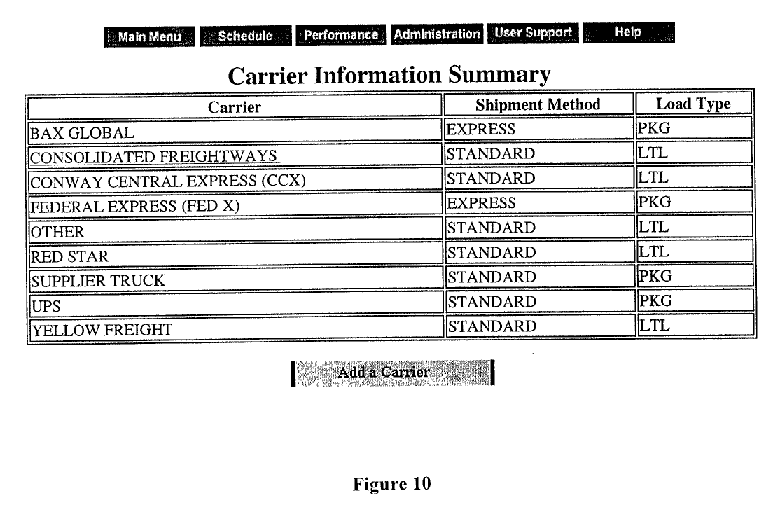

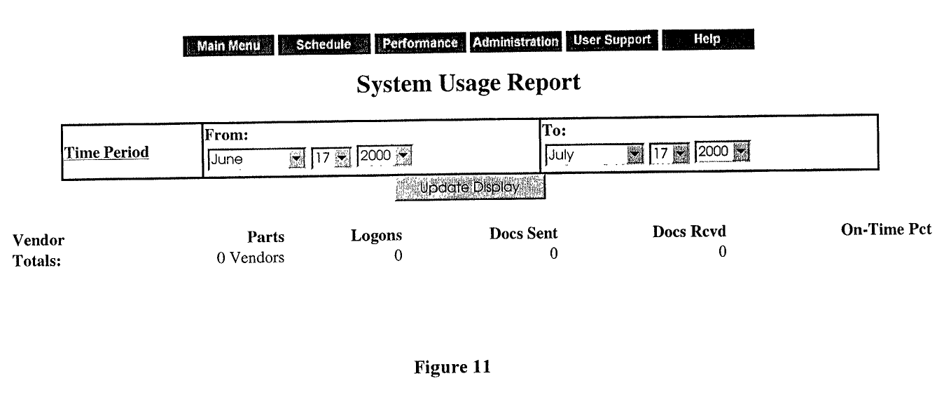

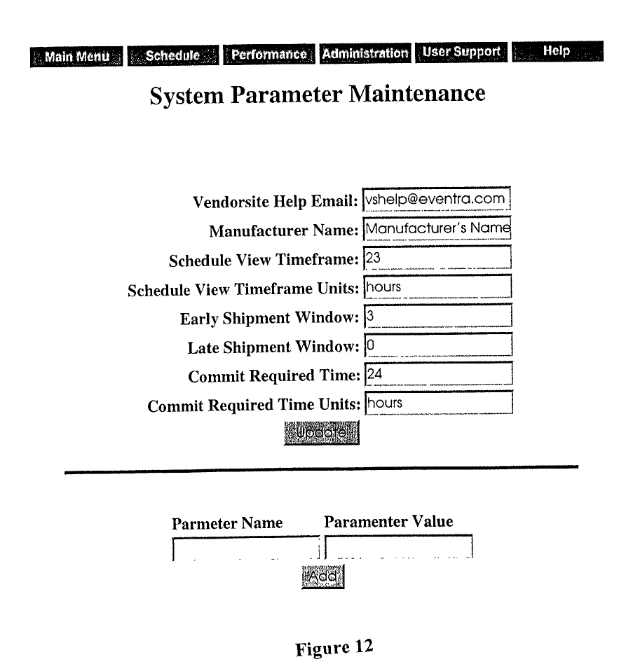

In a preferred embodiment of the present invention, after a user successfully logs into the SRMS Website for a particular manufacturer, there are multiple Webpages within the Website which may be viewed by the user, subject of course to the user's access privileges. For example, there are multiple Webpages that are available primarily for administrative and informational type reasons. Discussed previously, in preferred embodiments of the present invention, the SRMS provides a “Password Administration” page, an example of which is shown in FIG. 6, wherein users enter a password to access the SRMS. Users may view product and/or service information summaries organized by category, e.g., supplier, using the “Information Summary” screens, an example of which is shown in FIG. 7. For example, the SRMS holds a complete product and/or service information database with details regarding a given product and/or service. When a new product is introduced to the system, the SRMS creates a new record and automatically fills in all information available for that product from the manufacturer provided data stream (e.g., from the planning schedule or purchase order). Two displays control this process: the “Information Summary” screen in FIG. 7 that lists all products and/or services provided by a given supplier, and the “Information Detail” screen exemplified in FIG. 8 which provides details on each product and/or service. There are ship-to plant codes listed on the “Ship-To Plant Codes” screen and carrier information listed on the “Carrier Information Summary” screen, exemplified in FIGS. 9 and 10 respectively. There are also screens relaying SRMS system information such as system usage on the “System Usage Report” screen, system maintenance on the “System Parameter Maintenance” screen, and system audit reports on the “System Audit Report” screen, exemplified in FIGS. 11, 12, and 13, respectively. Other administrative, informational screens are also available through the SRMS and are discussed further below. The SRMS also provides complete on-line help for each screen function by clicking on the “Help” button located on each screen. Further, the SRMS provides a database search engine that allows the user to search the entire document database (DBMS) by a variety of criteria such as dates, document types, and keywords.

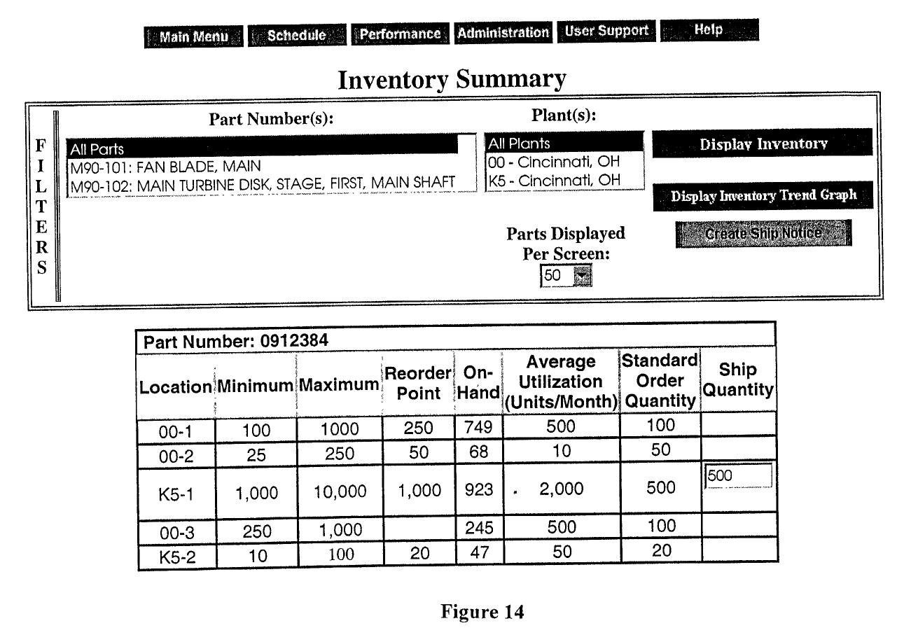

In a preferred embodiment of the present invention, manufacturer users of the SRMS utilize multiple Webpages in order to determine their manufacturing needs and to monitor supplier status and performance in meeting those needs. Exemplified in FIG. 14, an “Inventory Summary” screen summarizes a manufacturer's current inventory of products, according to, for example, location and reference number (e.g., part number). The “Inventory Summary” screen also includes values for the minimum and maximum requirements for the products, reorder points, precise product availability, average utilization of the product (e.g., units/month), standard order quantity, and standard shipping quantity. From this “Inventory Summary,” manufacturer personnel are able to determine what products and/or services they are going to need and at what time these products and/or services will need to be delivered. Inventory visibility enables manufacturers to implement supplier managed or consigned inventory programs while providing the supplier with information about the quantity and location of inventory in storage at a manufacturer's facilities. The inventory visibility feature provides the supplier with the data required to maintain safety stock quantities, forecast and plan production, quickly respond to pull triggers, and determine the appropriate time to invoice for consumed goods. Each plant/facility will provide inventory quantity and location information through the SRMS so that suppliers will be able to track the physical location of products they are carrying in their inventory.

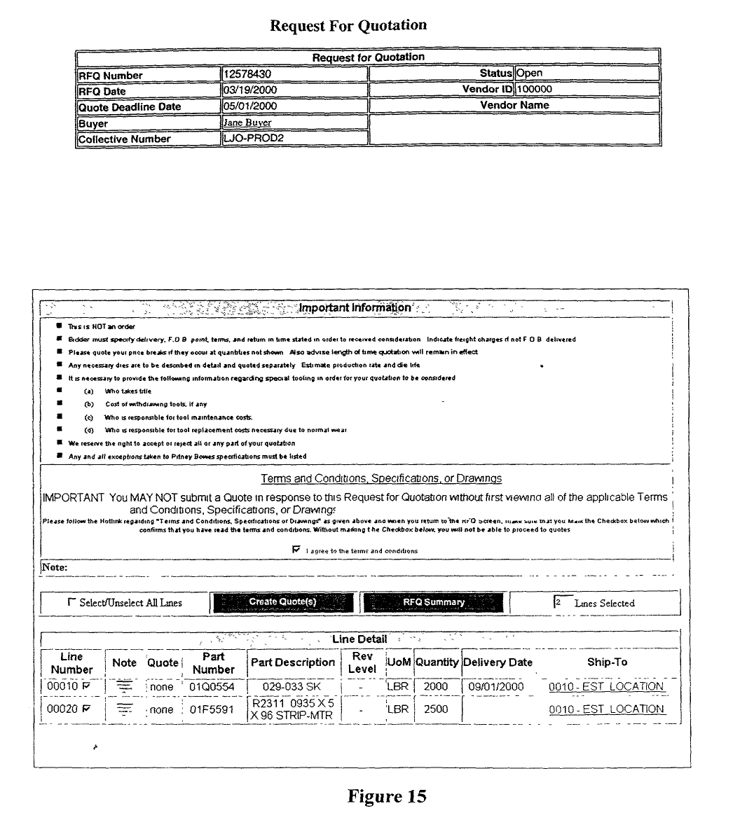

In a preferred embodiment of the present invention, the manufacturer uses a “Request for Quotation” (“RFQ”) screen, exemplified in FIG. 15, in order to obtain the needed products and/or services. The SRMS is designed to receive request for quotation (“RFQ”) data in an agreed to file format from a manufacturer. This data includes not only the RFQ, but also a listing of the suppliers selected to bid, including their name, address and e-mail address. In a preferred embodiment of the present invention, the manufacturer selectively sends the RFQ screen to particular suppliers registered with the manufacturer's SRMS. In an alternative embodiment, a manufacturer sends a “Request for Quotation” on the SRMS for viewing by all supplier's registered with the manufacturer's SRMS. In still a further alternative embodiment, the manufacturer sends the RFQ screen to all suppliers known by the manufacturer to provide the needed product and/or service in order to increase the supplier pool (e.g., suppliers not enrolled in the manufacturer's SRMS). Temporary SRMS user accounts are automatically created for all suppliers on the distribution list that are not current SRMS users. The SRMS sends an automatic e-mail alert to each supplier listed on the RFQ to inform them of the bidding opportunity. This e-mail alert contains information on the RFQ and a hot-link to the RFQ itself within the SRMS. For temporary users the e-mail alert will also contain an account user ID and password to use throughout the RFQ process. Throughout the bidding process, the suppliers have access to view and/or download information provided to the SRMS by the manufacturer in agreed to file formats such as Microsoft Word and Microsoft Excel formats. The manufacturer may then request that the supplier enroll in the manufacturer's SRMS in order to fulfill the RFQ. As shown in FIG. 15, the RFQ screen for a preferred embodiment includes information such as an RFQ reference number (e.g., RFQ Number), an RFQ post date, a quote deadline date, manufacturer personnel contact (e.g., manufacturer employee name) hot-linked to further contact information (e.g., e-mail address), supplier ID, supplier name, part number, part description, quantity, unit of measure, required delivery date, required ship-to location, and any other necessary information.

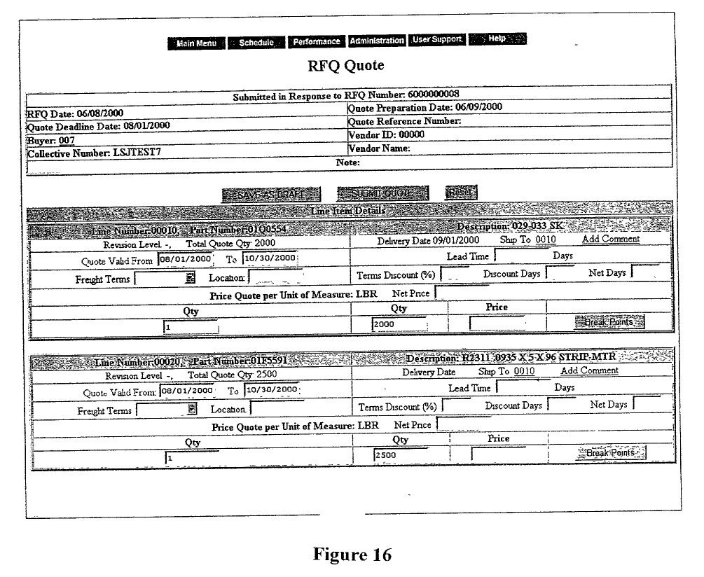

In response to the RFQ screen, suppliers may respond using an “RFQ Quote” screen exemplified in FIG. 16. In a preferred embodiment of the present invention, the “RFQ Quote” screen includes certain information identical to that of the “Request for Quotation” screen such as, RFQ Number, RFQ post date, Quote deadline date, manufacturer personnel contact information, supplier ID, supplier name, and part number. Further, the “RFQ Quote” screen includes information such as quantity requested by manufacturer, quantity available from supplier, price quote, the date range during which the quote is valid, freight terms (e.g., F.O.B.), and location being shipped from. Upon accessing the RFQ screen, the supplier selects the lines to quote then proceeds to the “RFQ Quote” screen. At the “RFQ Quote” screen the supplier fills in the price for each item requested along with delivery, and other requested information. Each supplier is required to answer questions provided by the manufacturer in the original RFQ. Once all required fields are populated, the supplier will click on a “Submit Quote” button. The supplier's quote will then be routed by the SRMS to the manufacturer in an agreed to file format. The SRMS will maintain a record of all RFQs sent and quotes received. Once this “RFQ Quote” screen is submitted to the SRMS by a supplier, the manufacturer can choose to accept the RFQ quote from the supplier during the valid dates.

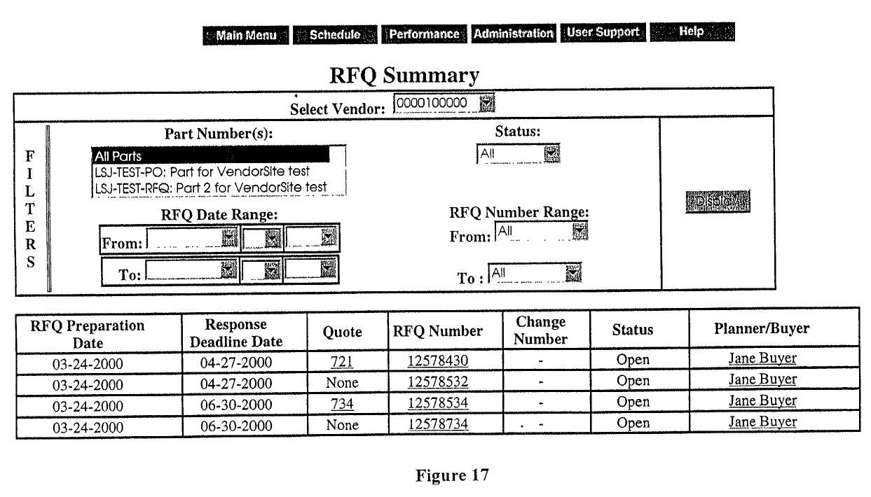

In a preferred embodiment of the present invention, the SRMS utilizes the SCMS application in order to formulate an “RFQ Summary” screen, exemplified in FIG. 17. Each supplier will have a listing of their RFQs and the status of each (e.g., “Received”, “Quote Sent”, “Quote Acknowledged”) viewable through the “RFQ Summary” screen. Further, the manufacturer may provide the SRMS with a hot-link to drawings and documentation associated with the RFQ through the “RFQ Summary” screen. The “RFQ Summary” screen also enables a manufacturer to selectively view all RFQ quotes according to different criteria. These criteria include by supplier, by part, by RFQ Number range, by RFQ date posted range, by status (e.g., open, closed, all) or by a combination thereof. The “RFQ Summary” screen, based on the criteria entered, provides a quote summary table that includes, for example, RFQ preparation date, response deadline date, quote, RFQ Number, change number (assuming there are revisions), status, and contact personnel information (e.g., manufacturer buyer/planner name). With a summary of submitted quotes to review, a manufacturer is able to compare the quote information and determine which quotes to accept.

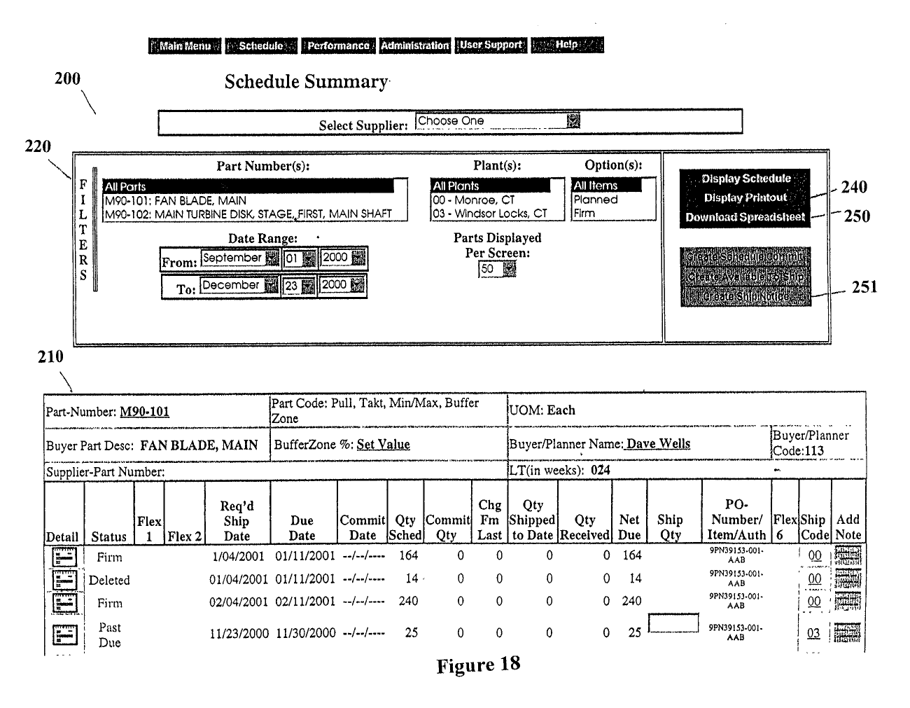

A manufacturer's material delivery requirements, also referred to as forecast and production schedule data is summarized on a “Schedule Summary” screen 200 as shown in FIG. 18 which is formulated by the SRMS using the SCMS application. These requirements may be derived from manufacturer data from a variety of sources including, but not limited to: planning schedule documents, purchase order documents, material release documents, Vendor Managed Inventory data and other data sources and data structures. The “Schedule Summary” screen provides the user with summary information on all parts delivery requirements to the manufacturer and tracks the status of these requirements from this point on in time until the requirement is fulfilled and completed. For example, the “Schedule Summary” displays the commit, shipment, receipt and payment information for each schedule item. Schedule data appears as a series of tables 210, one for each product and/or service that a particular supplier provides to the manufacturer. Using the filter section 220 at the top of the screen, the user can query the database to view all or selected tables 210. Individual searches by product or service number, date range, manufacturer plant or product status/options (e.g., all items, firm items, planned items, archive items, changes items, deleted items, excepted items, paid items, past due items, or shipped items), and/or number of products and/or services may be performed using the filter section 220. Via the “Schedule Summary” screen 200 a user may also choose to download the data to an appropriate application, e.g., an Excel spreadsheet, or view the data in a pure text mode for printing purposes using buttons 240 and 250.

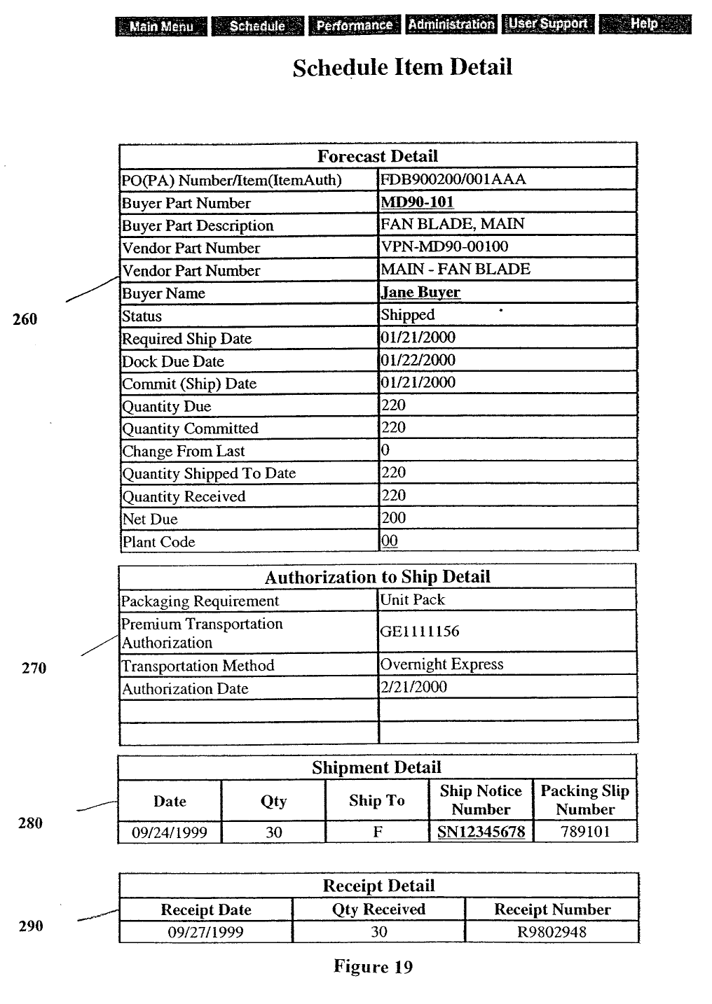

The table 210 is divided into rows and columns containing more detailed information such as product and/or service details, status, required shipping date, due date, ship date committed, quantity scheduled, quantity committed, change from last, quantity shipped-to date, quantity received, net due, ship quantity, purchase order number/release, ship/plant code, and configurable information headers, such as supply chain status, revision level, and schedule forecast. Each row in this table is called a Schedule Item and contains the above described data. Further, by clicking on the hot-links (e.g., hypertext links) located under the “detail” heading, a screen labeled “Schedule Item Detail” is shown as in FIG. 19. The “Schedule Item Detail” screen contains additional detail about the selected schedule item, including forecast detail 260, authorization to ship detail 270, shipment detail 280, and receipt detail 290. It also contains hot-links to related documents such as any ship notices or invoices that have been sent for this item or any receipt or payment information that has been received.

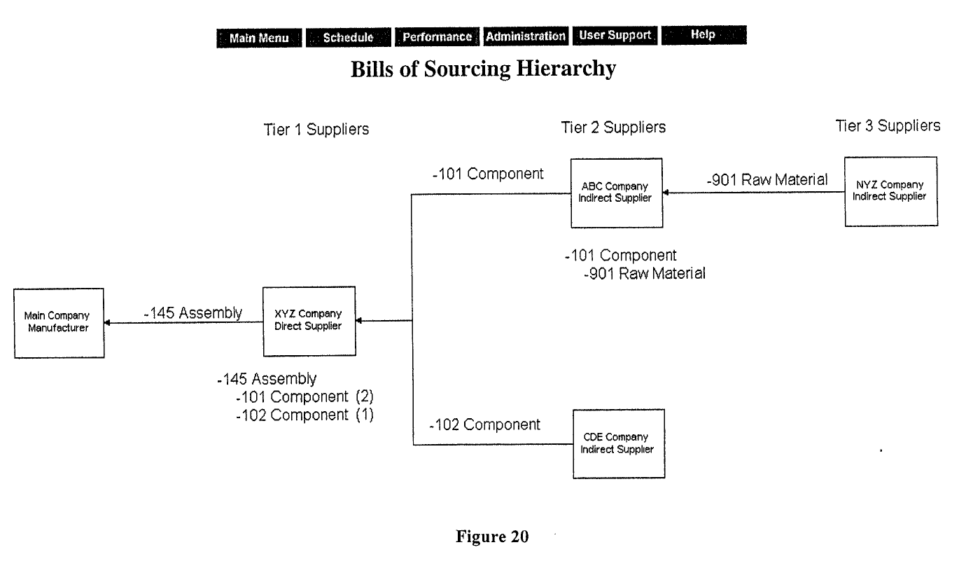

The header of each table in the “Schedule Summary” contains headings such as manufacturer and/or supplier product and/or service number, unit of measure (UoM), description, buyer/planner name, buyer/planner code, product or service code (e.g., pull, min/max, buffer zone, indirect), buffer zone percent, and lead time (“LT”). Some of these headings include hot-links, such as additional information about the product and/or service by clicking on the supplier product and/or service number and a link to an e-mail message addressed to the manufacturer's buyer/planner responsible for the product and/or service by clicking on the buyer/planner's name. Further, the product code allows users to view the demand status of a particular product. For example, in FIG. 18, the “Part Code” status is “Indirect Demand” which tells the user that within the supply chain, the source of that particular product is indirect. By clicking on the ovals 230, located under the heading within the table, “Supply Chain Status,” the user is provided with a “Bills of Sourcing Hierarchy” screen exemplified in FIG. 20, which allows the user to locate the position within the supply chain from which that particular part is forthcoming. For example, the “Schedule Summary” identifies the product as buyer part number “M90-101” and under the “indirect demand” part code. Comparing this information with the “Bills of Sourcing Hierarchy” screen, the user can establish that the component is from a Tier 2 supplier. This -101 component was formed at the Tier 2 indirect supplier based on -901 raw material from a Tier 3 indirect supplier. This multi-tier demand visibility allows users to better understand their role in the supply chain, resulting in more efficient supply chain management.

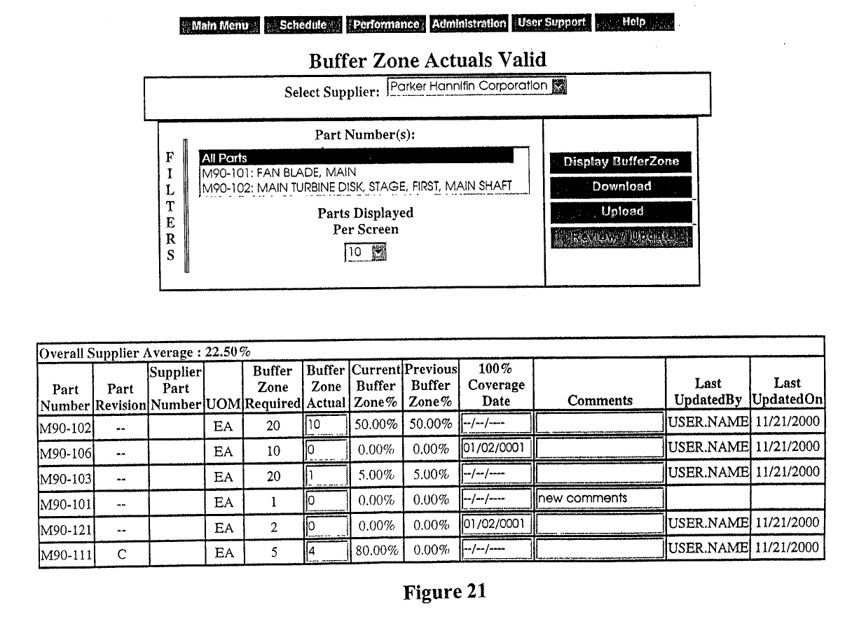

A screen linked to the “Schedule Summary” screen is a “Buffer Zone Actuals Valid” screen, exemplified in FIG. 21. The Buffer Zone is a quantity of parts established by the customer that determines the minimum number of parts a supplier must keep in their inventory to support the manufacturer's production schedule changes. The Buffer Zone is separate from other safety stock inventory maintained by the supplier at their facilities. In an embodiment of the present invention, the “Buffer Zone Actuals Valid” screen is supplier and part specific. All part numbers on the current schedule summary requiring a buffer zone will appear in the table for Buffer Zone Requirements. The buyer will access a supplier's Buffer Zone Requirements by selecting that supplier from a drop down list. The supplier will only be allowed to view Buffer Zone Requirements for their own parts.

Upon accessing the screen for the first time for each session, the user will see instructions on the use of the screen, similar to the schedule summary function. Instructions will be specific to the security level in which the screen is being accessed. Suppliers see different instructions than buyers/administrators. The filters at the top of the screen allow part filtering. The part filter only includes parts that require buffer zone tracking. One selection button will be provided to display the listing of parts once filter options have been selected.

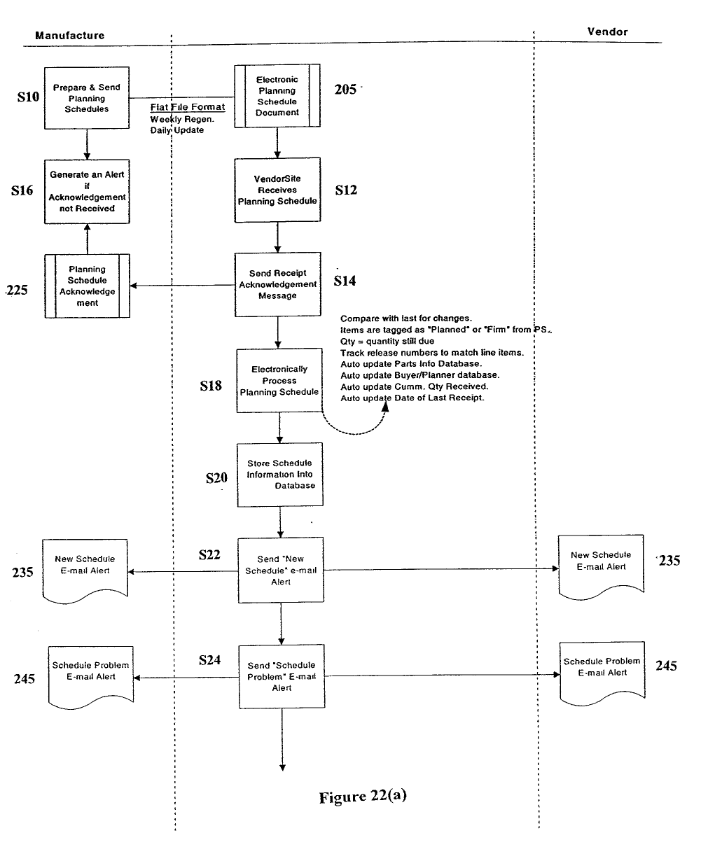

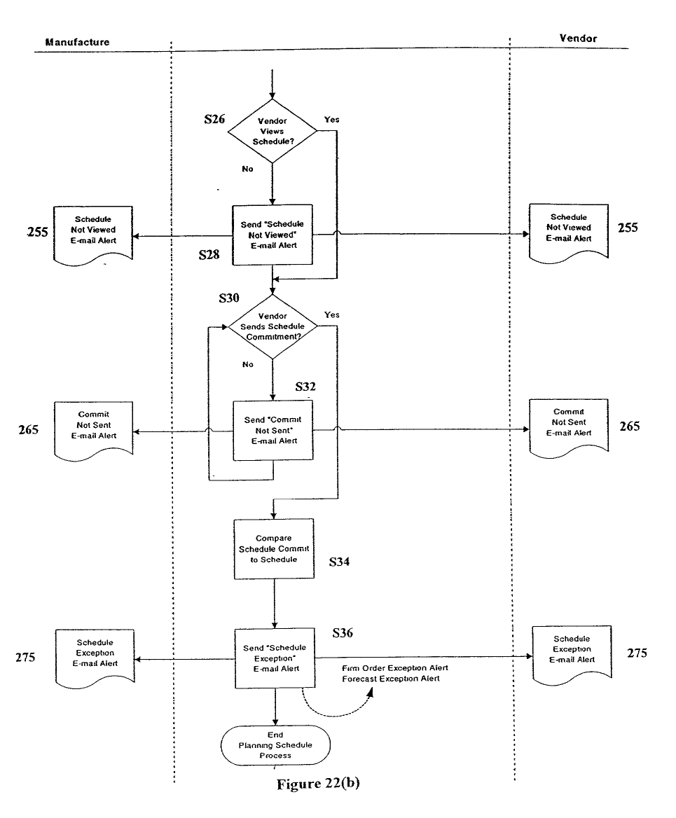

In a preferred embodiment of the present invention, a planning schedule process exemplified in FIGS. 22(a)-(b) enters data into the DBMS and utilizes existing DBMS data as follows. The manufacturer prepares and sends a planning schedule 205 to the SRMS in an appropriate format (e.g., flat file format) over a network (e.g., the Internet) S10. The electronic planning schedule is received at the SRMS S12 and the SRMS sends an acknowledgement of receipt to the manufacturer server S14. The manufacturer server receives the acknowledgement 225 and generates an alert for the appropriate manufacturer personnel, i.e., buyer/planner via an appropriate channel, for example, e-mail S16. The SRMS electronically processes the received planning schedule S18. This electronic processing includes, for example, comparing the received planning schedule with the previously received planning schedule in order to identify changes, tagging items with required labels (e.g., planned or firm), tracking release numbers to match line items, automatically updating the parts information database, the buyer/planner database, the quantity received, the date of last receipt, etc. The new schedule resulting from the electronic processing of the planning schedule is stored in the DBMS 50, S20. “New Schedule” alerts 235 (e.g., e-mail) are sent to interested users of the SRMS for that particular manufacturer S22. Similarly, if the SRMS encounters a scheduling problem during the electronic processing of the new schedule, the SRMS sends “Schedule Problem” alerts 245 to interested users of the SRMS for that particular manufacturer S24. Further exemplary information regarding the “Schedule Summary” screen is found in Provisional Application Nos. 60/213,324 and 60/250,507, both entitled “Method and System for Supply Chain Management” and incorporated herein by reference in their entirety.

Further to the planning schedule process, the SRMS queries whether or not the interested supplier(s) have viewed the “New Schedule” S26. If the supplier(s) have not viewed the “New Schedule” then the SRMS sends “Schedule Not Viewed” alerts 255 to the supplier(s) and the manufacturer S28. The SRMS queries whether or not the supplier has sent a schedule commitment to the SRMS S30. If not sent, “Commit Not Sent” alerts 265 are sent to the supplier(s) and the manufacturer S32. If sent, the schedule commitment is compared to the “New Schedule” S34. If there are any discrepancies, referred to as “Schedule Exceptions,” the SRMS sends “Schedule Exception” alerts 275 to the supplier(s) and the manufacturer S36. The “Schedule Exception” alerts may be divided into separate categories, such as, “Firm Order Exception” alerts and “Forecast Exception” alerts.

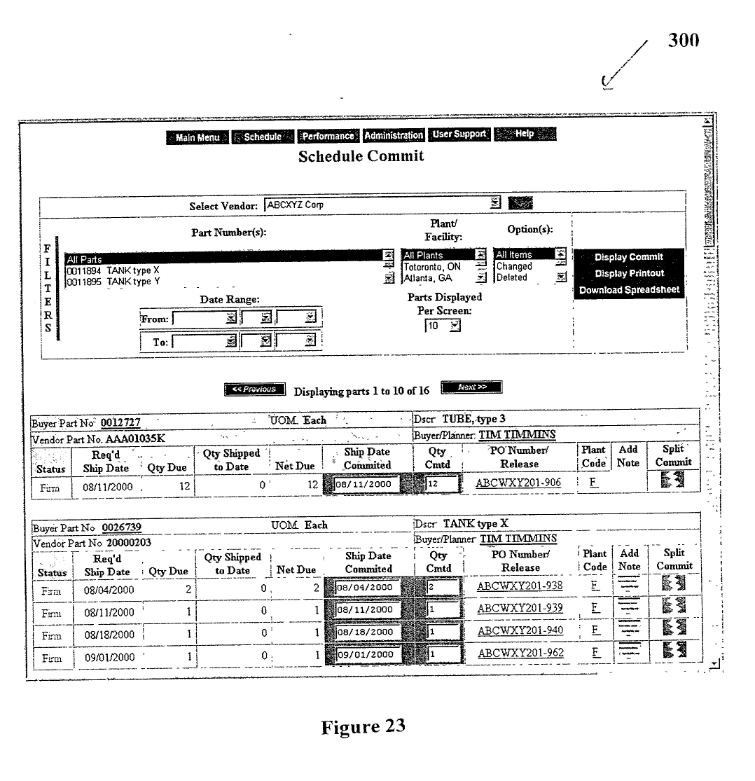

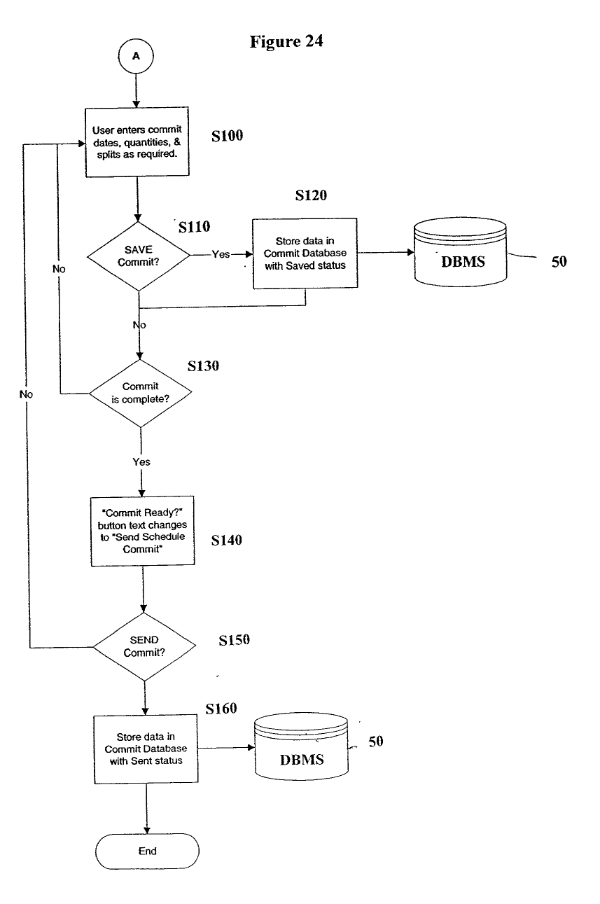

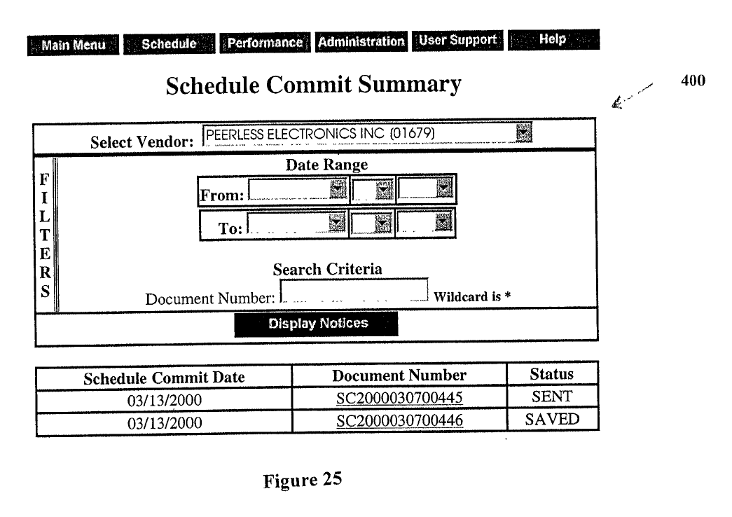

In FIG. 23, there is an exemplary “Schedule Commit” screen 300. The “Schedule Commit” screen 300 is useful for manufacturers whose business process requires their suppliers to provide “Commit” information to their planning schedule. The SRMS provides a “Schedule Commit” screen 300 using commit data entered. An exemplary business process flow for forming a commit schedule is shown in FIG. 24. Following the process flow of FIG. 24, a user enters commit dates, quantities, and required splits into the template provided via the “Schedule Commit” screen 300, S100. The user is prompted to save the entered data S10. If the user elects to save the entered data, the data is stored in the commit database within the DBMS 50, S120. If the user declines to save the entered data, the SRMS questions the completeness of the commit data S130. Assuming the data is incomplete, the process starts over at S100. If the data is complete, the “Commit Ready” prompt visible to the user changes to say, “Send Schedule Commit?” S140 and the user is prompted as to whether or not the user wishes to send the data to the DBMS for storage S150. If the user does not elect to send the data, then again the system presumes that the user needs to enter or change data and the process begins again at S100. If the user does elect to send the data to the DBMS, the commit data is saved within the DBMS S160. The “Schedule Commit” screen 300 provides the user with a mechanism to respond with a commitment to the most recent manufacturer's planning schedule (discussed below). The “Schedule Commit” screen 300 indicates the supplier's agreement with or exception to the due dates and quantities presented in the manufacturer's schedule. A summary of all “Schedule Commit” screen data is provided in a “Schedule Commit Summary” screen 400, an example of which is shown in FIG. 25.

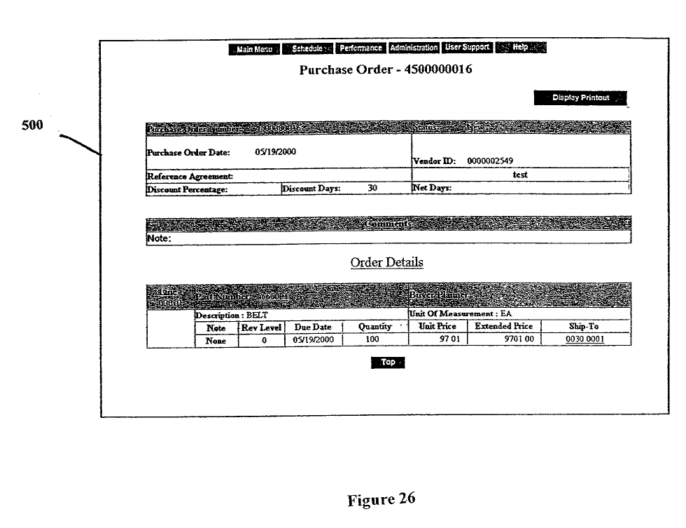

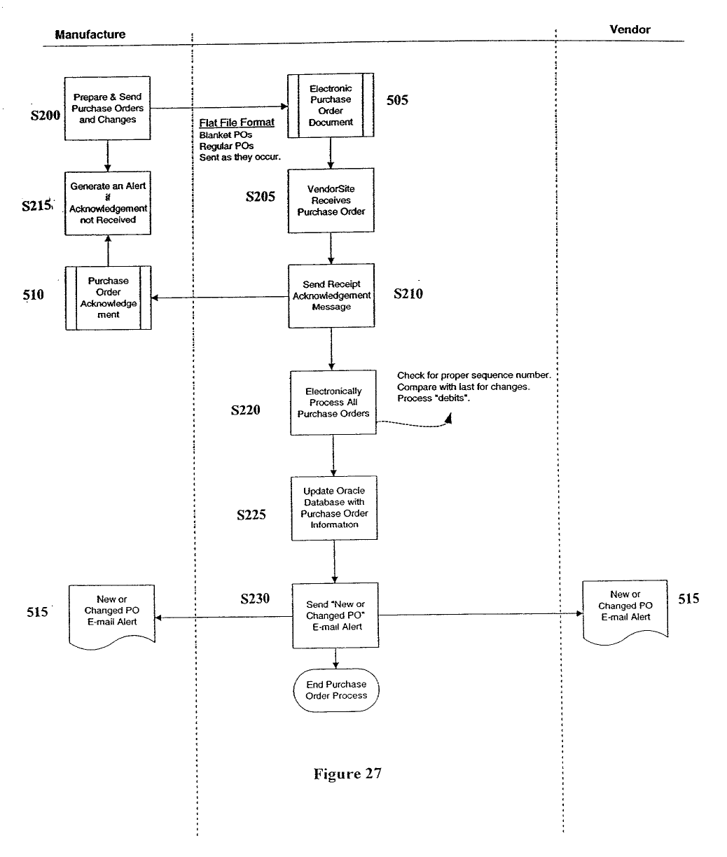

The SRMS facilitates the processing of manufacturer's “Purchase Order” documents and “Purchase Order Change” documents and data into the DBMS and facilitates their display. The SRMS links these documents, where possible, to the respective planning schedule line items from the schedule summary. This “Purchase Order” and “Purchase Order Change” document processing may also create new Schedule Items in the DBMS which are viewable via the “Schedule Summary” screen. FIG. 26 shows an example “Purchase Order” screen 500. FIG. 27 shows a purchase order process flow for an embodiment of the present invention. The manufacturer initiates the purchase order process by preparing and sending purchase orders (POs) and/or changes to POs S200 to the SRMS in a recognizable format (e.g., electronic flat file format) 505. The POs can be, for example, blanket POs, which reference goods or services that a customer intends to buy from a supplier either over a stated or unspecified period of time, or discrete POs, which are one-time purchase orders that specify the quantities, due dates, and terms and conditions of all parts or services ordered. The SRMS receives the POs S205 and sends a PO receipt message 510 (e.g., e-mail) to the manufacturer S210. The manufacturer receives the PO receipt message 510 and generates an alert for the appropriate manufacturer personnel, via for example, e-mail S215. In addition to sending a PO receipt message 510 to the manufacturer, the SRMS electronically processes the received POs S220. Electronic processing includes, for example, checking for proper sequence numbers, comparing recently received POs with previous POs for changes, creating new Schedule Items or changing existing Schedule Items, and debit processing. The SRMS updates the appropriate database within the DBMS 50 with the latest PO information S225. Based on the most recent PO information received from the manufacturer, the SRMS sends a “New PO” or “Changed PO” alert 515 to the manufacturer and the interested supplier(s) S230. The POs and PO changes may be viewed and printed.

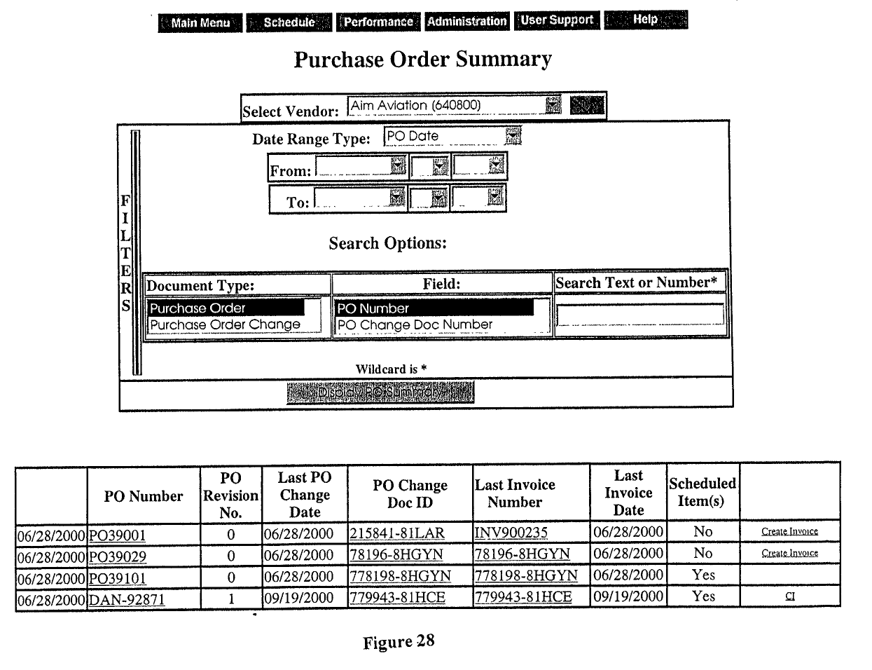

A summary of all “Purchase Order” documents is provided on the “Purchase Order Summary” screen exemplified in FIG. 28. A user may select summaries based on supplier, various date ranges (e.g., PO Date), document type (e.g., PO, PO change), field (e.g., PO Number, PO Change Document Number), and/or other text or number entered manually. The summary tables include headings and information such as PO date, PO Number, PO Revision Number, Last PO Change Date, PO Change Document ID, Last Invoice Number, Last Invoice Date, Scheduled Items (e.g., were these items purchased in response to a Schedule Commit?), and a hyperlink to an invoice creation screen. In addition, hot links among others, to e.g., the related POs and PO change documents are provided, where PO's and PO change documents are listed within the summary tables.

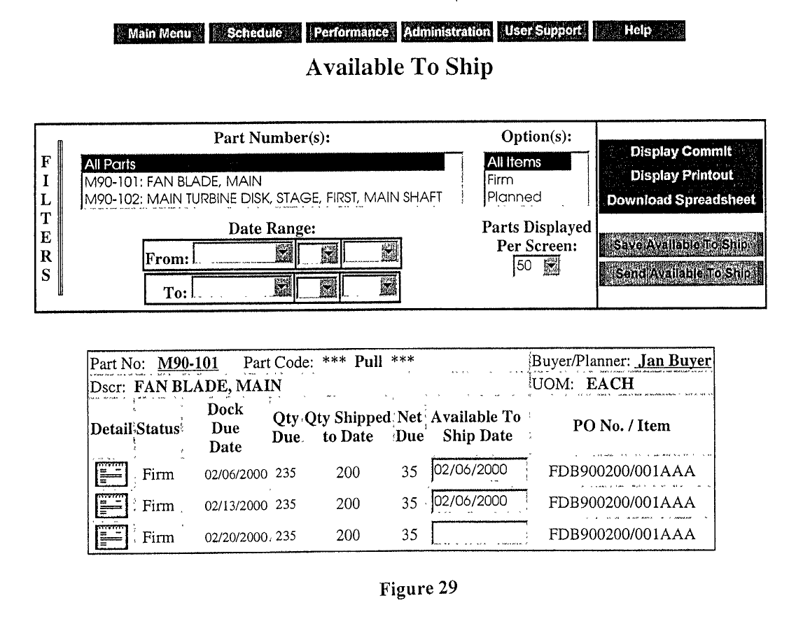

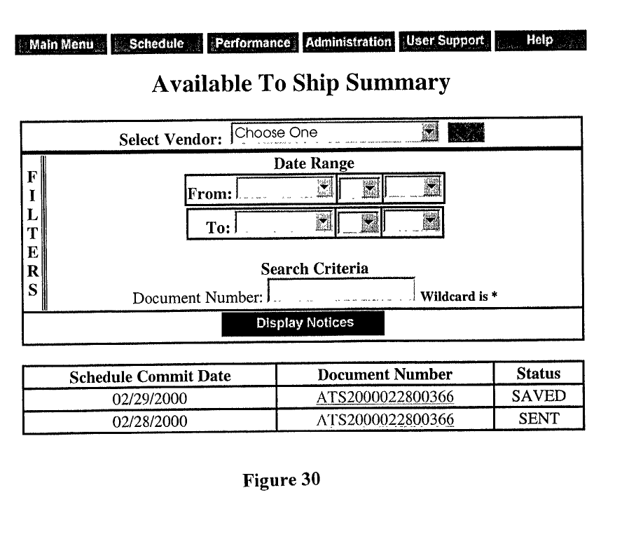

In a preferred embodiment of the present invention, the manufacturer requires that their suppliers provide notification when products are available to ship from the supplier to the manufacturer. This is accomplished through the SRMS using an “Available to Ship” screen exemplified in FIG. 29. The “Available to Ship” screen provides the user with a mechanism to alert the manufacturer that a specific quantity of products is completed and ready to be packaged for shipment to the manufacturer. The SRMS is able to track the products using schedule items from the Schedule Summary and/or PO numbers. The “Available to Ship” screen allows suppliers to provide shipment availability notices for multiple products simultaneously. Using filters such as product number, options (e.g., Firm, Planned, All Items), and date range, a supplier is able to view and provide available-to-ship dates for multiple line items and/or PO numbers. Once completed, the supplier can save and/or send the notifications to the manufacturer through the SRMS. The SRMS updates the manufacturer's Schedule Summary upon receiving the available to ship information. Further, the “Available to Ship Summary” screen, is composed by the SRMS based on the information provided by the supplier through the “Available to Ship” screens. An “Available to Ship Summary” screen, exemplified in FIG. 30 summarizes for the supplier based on supplier, date range, or other manually entered search criteria (e.g., document number) which shipment availabilities have been sent or saved, based on schedule commit date and availability to ship document number.

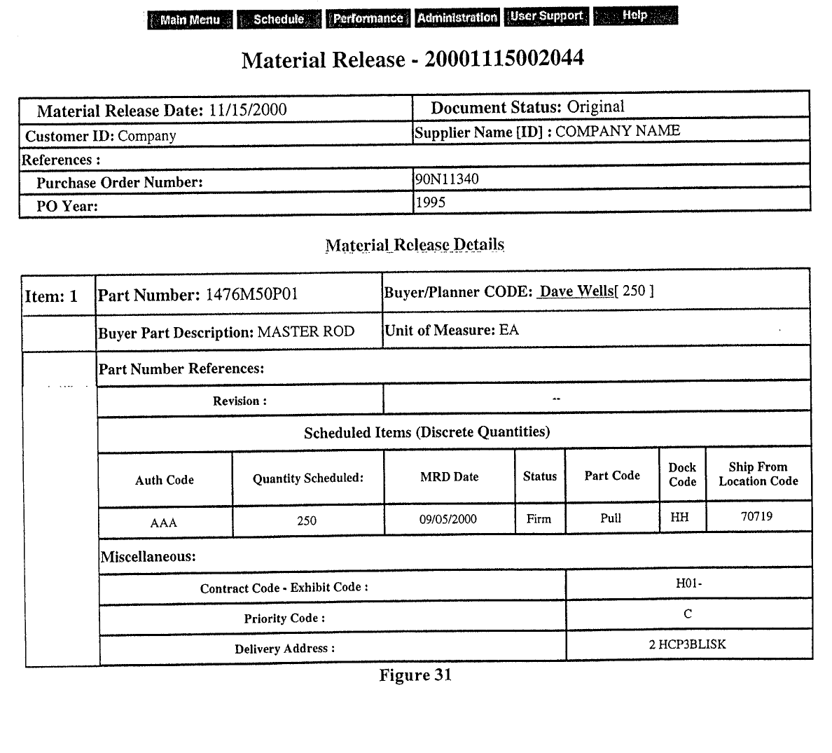

In this embodiment, in order to commence the shipping of the available products, the supplier must wait for each schedule item or PO number to receive a status of “Authorized to Ship.” The manufacturer can tag the items manually or, in an alternative embodiment of the present invention, through a Material Release process whereby a manufacturer determines when to allow a supplier to ship parts against a Schedule Item by setting up trigger configurations. Alternatively, the SRMS may tag the item automatically based on criteria established by the manufacturer and stored within the DBMS. The SRMS provides multiple configurable options that provide flexibility for authorizing the supplier to ship including: time-based (system default), Kanban triggers, supplier managed releases, and system generated approvals. An example of a “Material Release” screen is shown in FIG. 31. The Material Release process restricts the “Ship Quantity” window from being opened until the manufacturer is ready for parts to be delivered. The “Ship Quantity” window is a component of the “Schedule Summary” screen and therefore, the Materials Release process described below may also impact the “Schedule Summary” screen.

The Material Release process is defined at the Schedule Item level. The manufacturer defines a material release classification code for each Schedule Item or each part number. When defined by the manufacturer at the part number level, the system associates the part assignment to each Schedule Item for that part. The manufacturer passes the information through an inbound document. The material release classification code defines which of the multiple configurable options is used. The material release classification codes include, but are not limited too, 1=Time Based, 2=Authorization to Ship (Pull Trigger), 4=Synchronous to Rate, 3=Supplier Managed Reordering, and 5=System Generated Authorization to Ship.

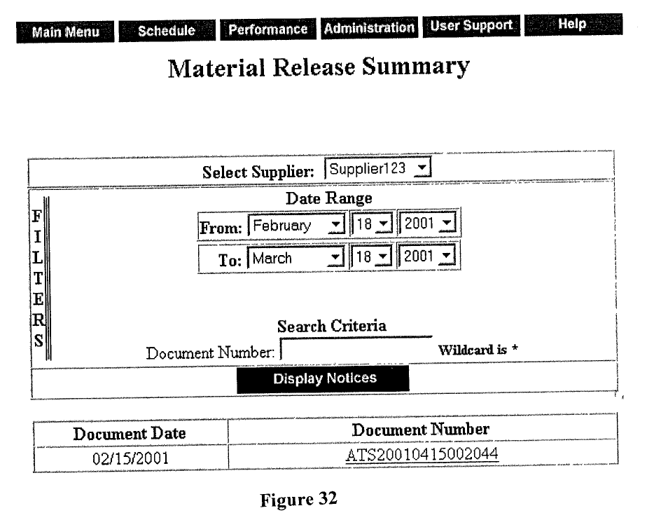

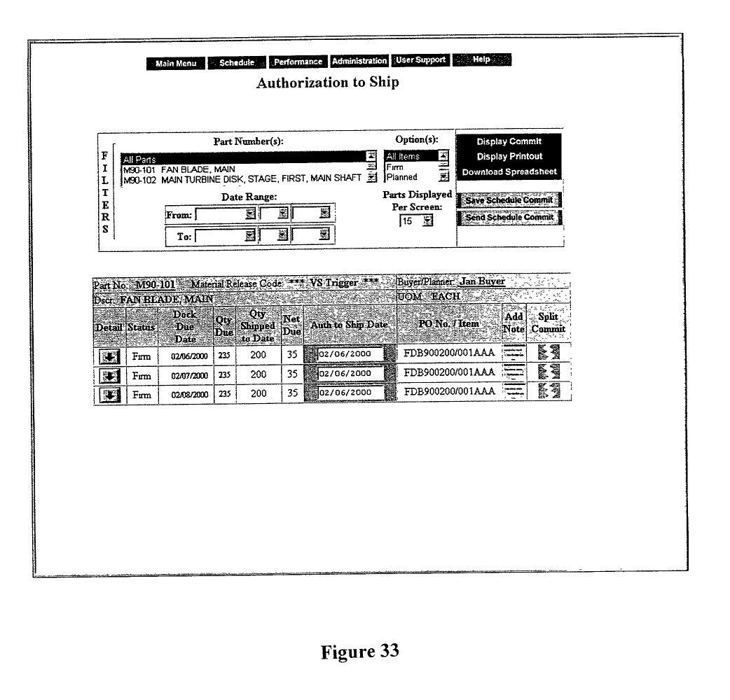

A “Material Release Summary” screen, exemplified in FIG. 32 summarizes for the user based on supplier, date range, or other manually entered search criteria (e.g., document number) which “Material Release” documents have been received, based on document date and number. Further, referring to FIG. 33, the manufacturer utilizes an “Authorization to Ship” screen to create an Authorization to Ship trigger from within the system to allow the Manufacturer to utilize pull trigger releases without having to implement this functionality in their MRP/ERP environment. The “Schedule Summary” of FIG. 18 shows an additional button for the buyer/planner titled Create Authorization to Ship and clicking on this button will bring up a new buyer/planner accessible “Authorization to Ship” screen, exemplified in FIG. 33 to display all Firm requirements that are classified as a system generated Pull Trigger. The buyer/planner fills in a date that the schedule line item is Authorized to Ship for each item displayed. The buyer/planner can choose to leave some of the schedule line item Authorize to Ship dates blank signifying that the part's “Ship Quantity” window should not be opened.

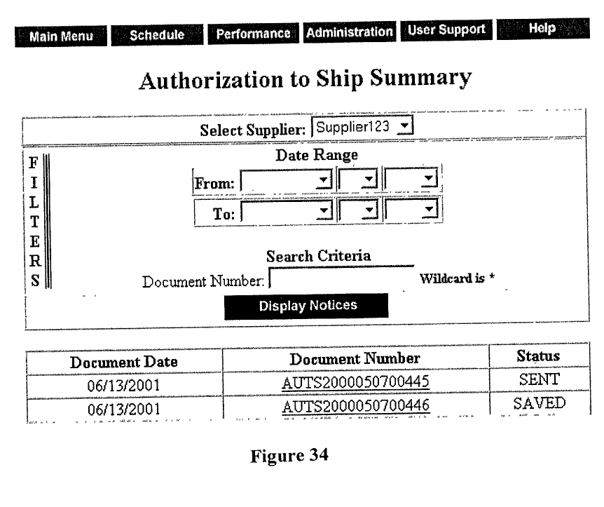

The buyer/planner can choose to Save Authorization to Ship or Send Authorization to Ship during entry of dates on the “Authorization to Ship” screen. The Save Authorization to Ship will store this data without processing through the system database. A menu option from the “Authorization to Ship” screen is displayed for the buyer/planner. Clicking on this button will bring the buyer/planner to a summary of all “Authorization to Ship” documents that he/she has created. An example of this summary screen is shown in FIG. 34. When the buyer/planner chooses the Send Authorization to Ship, the system processes a status change for the schedule item showing it as Authorized to Ship (AuTS). Upon completion of the status change, the “Ship Quantity” window on the “Schedule Summary” screen is activated so the supplier can enter the quantity to be shipped and create the “Advance Ship Notice” (ASN). This functionality occurs regardless of Due Date for the schedule item allowing both early and past due shipments.

In the embodiment wherein the manufacturer uses the SRMS to manually form the “Authorization to Ship” screen based on the “Available to Ship” screens submitted by the supplier, the manufacturer has a “check box-like” field for each schedule line item and/or PO number displayed on the “Available to Ship” screen. The manufacturer can check off the items that he/she wants to authorize to ship and click on the “Create Authorize to Ship” screen header (not shown). When the manufacturer clicks on the “Create Authorize to Ship” screen header, the SRMS processes this status change for the checked schedule items. Upon completion of the status change, the SRMS status of the line item changes to “Authorized to Ship” and the “Ship Quantity” data entry box on the “Schedule Summary” screen is activated so the supplier can enter the quantity to be shipped and create the advanced ship notice (ASN). This functionality occurs regardless of due date for the schedule item, allowing both early and past due shipments.

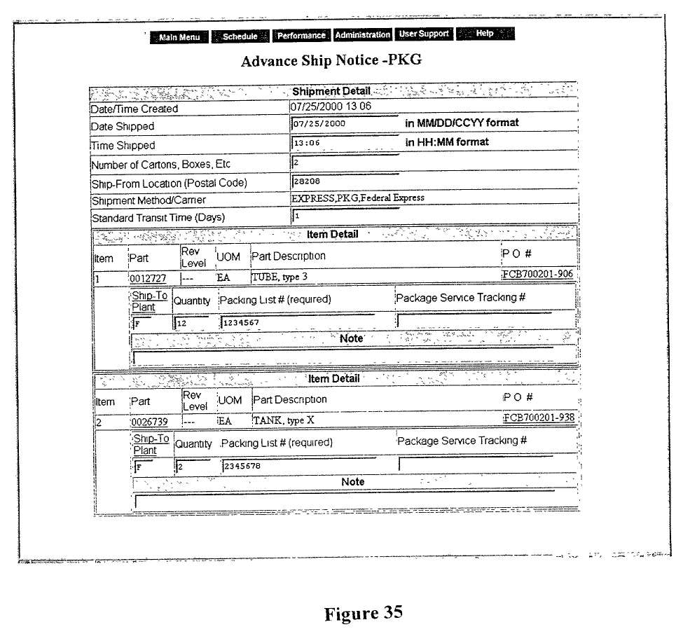

In a preferred embodiment of the present invention, in order to notify the manufacturer that materials have been shipped, the supplier utilizes a “Ship Notice” screen (also referred to as an “Advance Ship Notice” or “ASN” screen), exemplified in FIG. 35. In order to create the “Ship Notice” screen, referring to FIG. 18, the supplier accesses his/her “Schedule Summary” and enters the quantity of items that have been shipped in the appropriate column for the sent items. The supplier then clicks on the “Create Ship Notice” button 251 to start the process of creating a ship notice. The “Ship Notice” screen is completed by the supplier and submitted to the manufacturer using the “Send ASN” button. The “Ship Notice” screen may contain at least some or all of the following information: date/time created; date shipped; time shipped; packaging code; number of cartons, boxes, crates, etc.; shipment bill of lading number; ship-from shipment location, i.e., postal code; authorized shipment method/carrier; shipment method/carrier utilized; item number (e.g., where multiple items shipped); product number; revision level; product description; quantity; unit of measure; PO Number; ship-to plant; total; units per; pack code; packing list number; and package service tracking number. The SRMS then updates the DBMS with the shipment information including a new, calculated net due quantity which is reflected in the “Schedule Summary.” The completed “Ship Notice” screen may be saved in addition to, or as an alternative to submitting the screen to the manufacturer. There are separate “Ship Notice” screens depending on the type of the shipment. For example, a “Ship Notice—LTL” screen is used to describe a shipment that is a consolidation of a number of boxes into a skid or pallet and is shipped via common carrier trucking company. The “LTL” stands for less than truck load. A “Ship Notice—PKG” screen is used to describe a shipment that is carried by a package carrier such as UPS or Airborne Express. Further exemplary information regarding the “Ship Notice” screens is found in Provisional Application Nos. 60/213,324 and 60/250,507 both entitled “Method and System for Supply Chain Management” and incorporated herein by reference in their entirety.

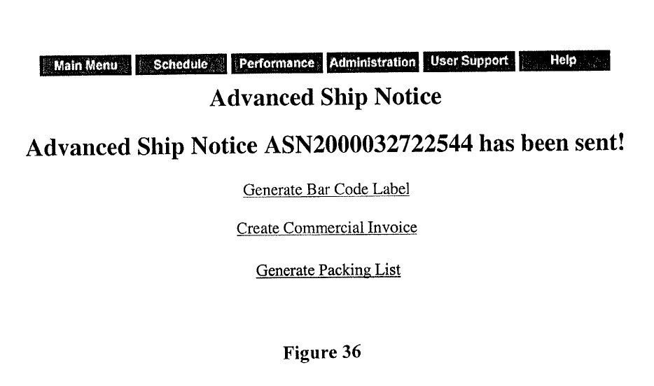

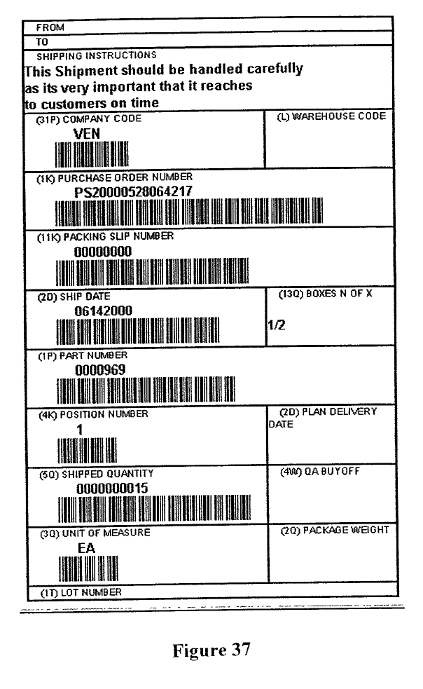

In a preferred embodiment of the present invention, the SRMS provides a barcode label process as a mechanism for the supplier to generate and print out barcode labels that conform with the content and structure of the SRMS Ship Notice documents. The barcode label process is configurable to allow for the creation of barcode labels that conform to various user requirements. As discussed above, the user first creates an Advance Ship Notice that indicates the items and quantities that are to be shipped. In alternative embodiments of the present invention, the Advance Ship Notices are either saved or sent. After saving or sending the Advance Ship Notice the user is presented with an “Advanced Ship Notice” screen, exemplified in FIG. 36. FIG. 36 indicates that the Advance Ship Notice has been sent. In an embodiment of the present invention, the user selects “Generate Barcode Label(s)” on this display to begin the Barcode label process. A Barcode Label List screen, exemplified in FIG. 37, lists all the Barcode Labels generated. The user selects a label from the list and the actual Barcode Label format appears on the browser screen. The user uses the browser's Print function to print the label. The labels may be printed one at a time or in a batch that prints them all out at once.

The Barcode Label List display allows the user to indicate how many copies of each label are to be printed. This is to allow for the common practice of putting one label on the outside of the box and including another inside the box as well as additional copies needed for record keeping by the user. The bar codes are configured using several scalar and array (or hash) variables set as follows:

CFG_BLOCK_COUNT = 12;
BLOCKS_LAYOUT = (1,1,1,2,1,1,2,1,2,2,2,1);
BLOCKS_CONTENT = (1=>‘FROM’, 2=>‘TO’, 3=>‘SHIPINS’,
41=>‘COMP’, 42=>‘WARE2 , 5=>‘PO’, 6=>‘PKSLP’,
71=>‘SHIPDT’, 72=>‘CTN’, 8=>‘PARTNO’, 91=>‘POSNO’,
92=>‘PDELDT’, 101=>‘QTY’, 102=>‘QABO’, 111=>‘UM’,
112=>‘PKGWT’, 12=>‘LOTNO’);
BLOCKS_TEXT = (FROM=>‘FROM’, TO=>‘TO’,
SHIPINS=>‘SHIPPING INSTRUCTIONS’, COMP=>‘(31P)
COMPANY CODE’,WARE=>‘(L) WAREHOUSE CODE’,
PO=>‘(1K) PURCHASE ORDER NUMBER’,PKSLP=>‘(11K)
PACKING SLIP NUMBER’, SHIPDT=>‘(2D) SHIP DATE’,
CTN=>‘(13Q) BOXES N OF X’, PARTNO=>1(1P) PART NUMBER’,
POSNO=>‘(4K) POSITION NUMBER’, PDELDT=>‘(2D) PLAN
DELIVERY DATE’,
QTY=>‘(5Q) SHIPPED QUANTITY’, QABO=>‘(4W) QA BUYOFF’,
UM=>‘(3Q) UNIT OF MEASURE’,
PKGWT=>‘(2Q) PACKAGE WEIGHT’, LOTNO=>‘(IT)
LOT NUMBER’);
BARCODES = (1=>0, 2=>0, 3=>0, 41=>1, 42=>0, 5=>1, 6=>1,
71=>1, 72=>0, 8=>1, 91=>1, 92=>0, 101=>1, 102=>0, 111=>1,
112=>0, 12=>0);

Together with additional variables known to one skilled in the art, this method allows a barcode display to be configured for each manufacturer. The method provides for display of the resulting barcode, and printing of the resulting barcode(s) on labels.

Further, the supplier may use a printout of the “Advance Ship Notice” screen as a packing list. This packing list is generated by selecting the “Generate Packing List” button on the “Advance Ship Notice” screen. The packing list generated from FIG. 36 is filtered so as to only include the information necessary to indicate the contents, etc.

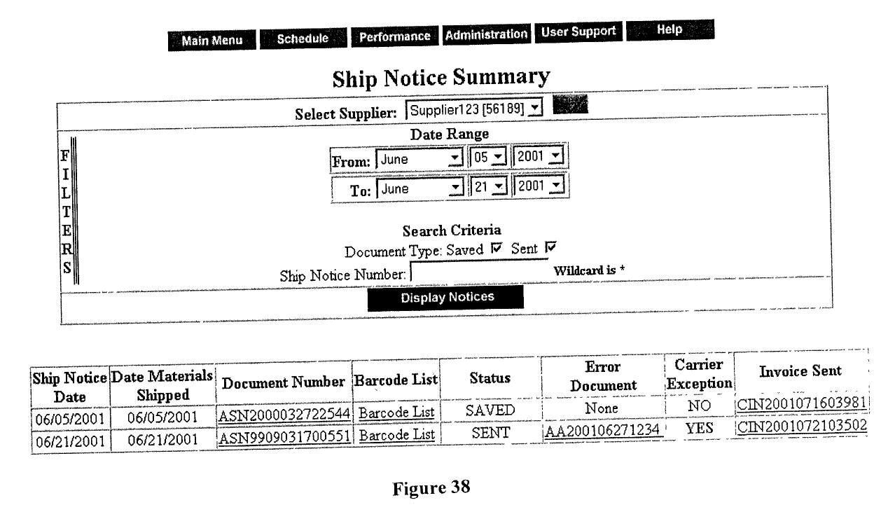

The SRMS maintains a history of all ship notices that have been sent or saved. This history and status is viewable in a “Ship Notice Summary” screen, exemplified in FIG. 38.

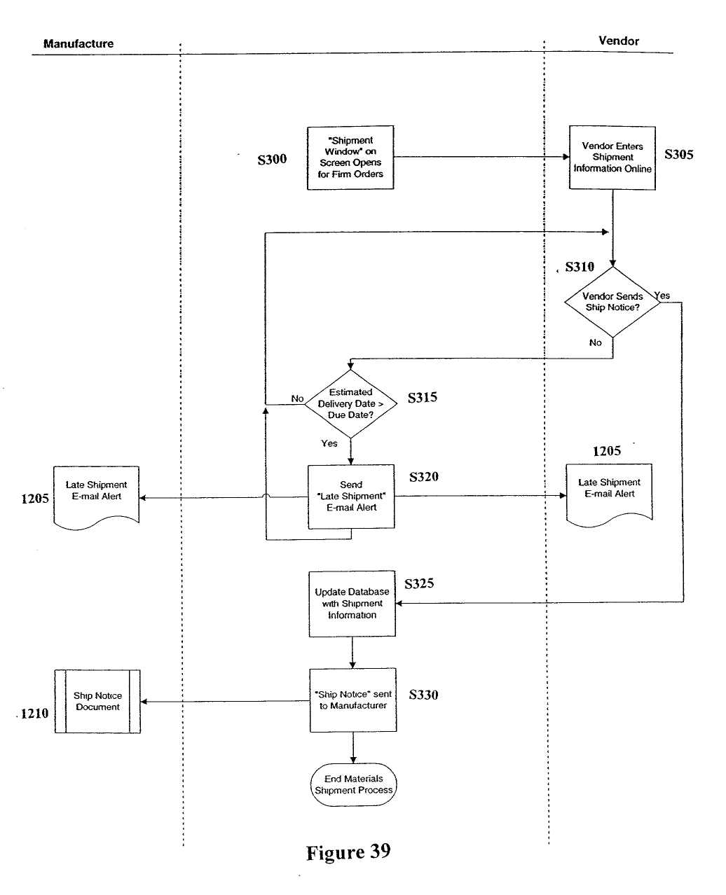

A process for shipping materials according to an embodiment of the present invention is shown in FIG. 39. As discussed above, the SRMS provides a “Ship Notice” screen to the supplier for completion through at least the “Create Ship Notice” 251 button on the “Schedule Summary” screen FIG. 18, S300. The “Create Ship Notice” button opens the “Ship Notice” screen for those schedule items for which the user has entered quantity information into the “Ship Quantity” window on the “Schedule Summary” screen. The supplier enters shipment information into the dynamic “Ship Notice” screen S305 and attempts to send the “Ship Notice” data to the manufacturer through the SRMS S310. If the supplier is unable to send the “Ship Notice” data for lack of complete information, the SRMS prompts the supplier to enter the necessary information (steps not shown). Alternatively, in the embodiment described in FIG. 39, if the necessary information has been entered, but the estimated delivery date is beyond the due date listed on the “Schedule Summary” screen, the SRMS prompts the supplier to confirm the entered delivery date S315. If the estimated delivery date is not later than the required due date, i.e., the supplier entered an incorrect delivery date, the supplier re-enters the correct date and the vendor attempts to send the “Ship Notice” screen again S310. If the supplier does not enter and send a Ship Notice for a schedule item by the end of the due date, the SRMS sends a “Late Shipment” alert 1205 (e.g., via e-mail) to both the manufacturer and the supplier S320. Assuming the supplier is able to send the “Ship Notice” screen to the manufacturer at S310, the SRMS updates the appropriate database within the DBMS 50, S325 with the shipment information and forwards the “Ship Notice” document 1210 to the manufacturer S330. Alternatively, in the embodiment described in FIG. 39, the manufacturer may choose to not have the document sent to them.

Referring again to FIG. 38, the SRMS maintains a “Ship Notice Summary” screen containing ship notice date, date materials shipped, advance ship notice document number, the status (e.g., saved or sent) of the ship notice and optionally, other information. The notices displayed may be filtered according to supplier, date range, status, or other applicable search criteria (e.g., ship notice number). Further exemplary information regarding the “Ship Notice Summary” screen is found in Provisional Application Nos. 60/213,324 and 60/250,507 both entitled “Method and System for Supply Chain Management” and incorporated herein by reference in their entirety.

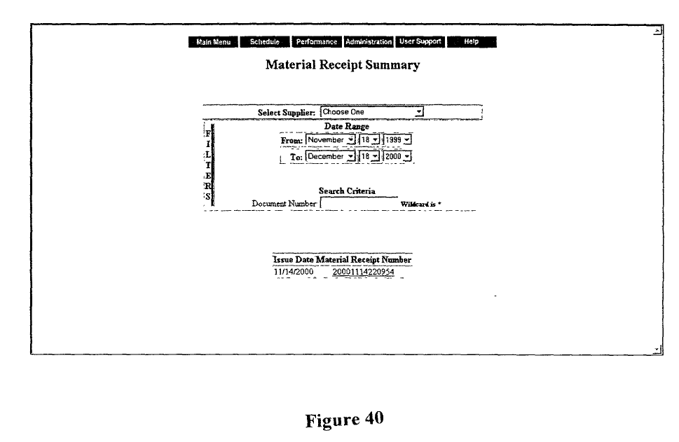

The manufacturer can send material receipt information to the SRMS which information is viewable by the supplier. In an alternative embodiment, this information can also be shown on the “Schedule Summary” screen. The material receipt information includes material receipt number, receipt issue date, ship-to plant code, ship-to location code, PO number, PO date, manufacturer product number, unit of measure, product description, manufacturer contact person (e.g., buyer/planner), cumulative quantity received, from date, to date, release number, release day of the week, quantity ordered, cumulative quantity due, cumulative quantity received to-date, date of last receipt. Further, as shown in FIG. 40, a “Receipt Notice Summary” screen lists all “Receipt Notice” documents.

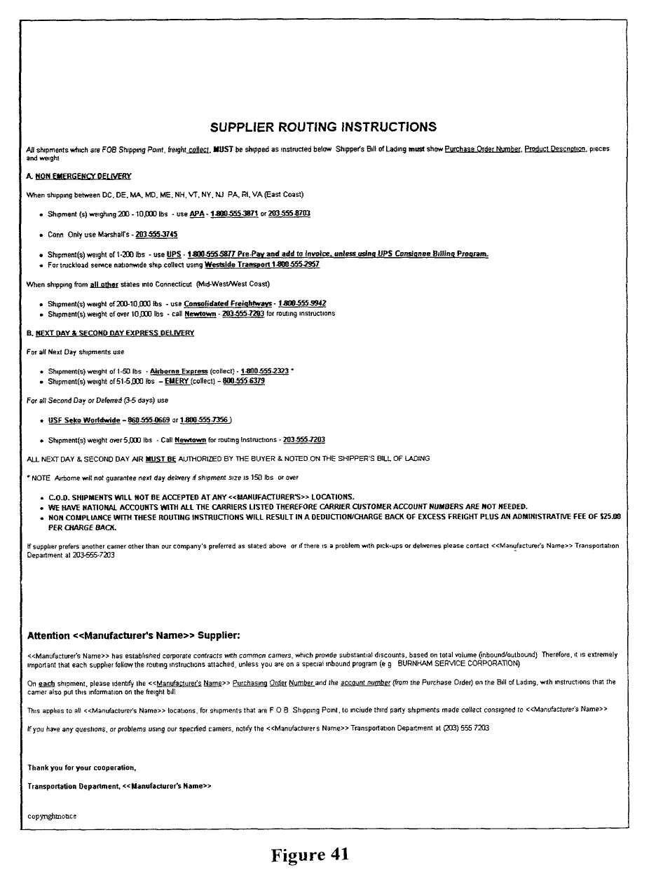

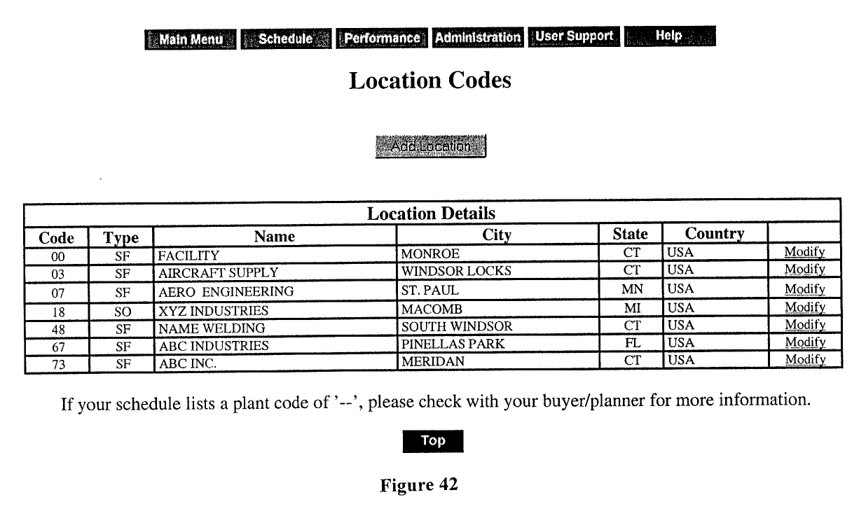

As discussed above with reference to the administrative Webpages that are available through the SRMS, the SRMS provides supplier routing and shipping codes and instructions through a “Supplier Routing Instructions” screen such as that shown in FIG. 41. The “Supplier Routing Instructions” screen contains the manufacturer instructions on which authorized carriers to use under varying circumstances. A “Location Codes” screen shown in FIG. 42 lists all manufacturer plant codes with their address details. The supplier routing and shipping code screens are configurable on-line by an SRMS administrator and/or a manufacturer.

In a preferred embodiment of the present invention, the SRMS provides a “Shipment Tracking” screen (not shown). This display contains hot-links to commercial shipment tracking websites such as those provided by UPS, Consolidated Freightways and Federal Express. When a supplier and/or buyer decides to track a shipment, suppliers can click on a hot-link provided on the “Shipment Tracking” screen and be linked to the proper carrier web site for further tracking. In an alternative embodiment, the SRMS is configured with an on-line shipment tracking module, wherein the SRMS is linked to the tracking servers of the commercial shipping companies and automatically retrieves the tracking information from these servers when a tracking request is made by a user of the SRMS. For example, a user may click on the tracking number provided on the “Ship Notice” screen and be hot-linked to the “Shipment Tracking” screen, wherein instead of listing hot-links to the commercial packaging Websites, the user is provided with the current tracking information for the tracking number. The SRMS retrieves the tracking information automatically from the appropriate commercial shipping company's server and provides the information to the user via an SRMS screen such as the “Ship Notice Summary” screen. In a further embodiment of the present invention, the SRMS is configured with an on-line shipment tracking module, wherein the SRMS is linked to the tracking servers of one or more logistics information service providers. The SRMS sends shipment information to these servers whenever a ship notice is sent and automatically receives back from these servers, periodically as the information changes, information about the status of the shipment such as; its present location or that the shipment will be late. In this embodiment, a user may also click on the tracking number provided on the “Ship Notice” screen to cause the SRMS to exchange information with these servers that updates the present shipment status information within the SRMS.

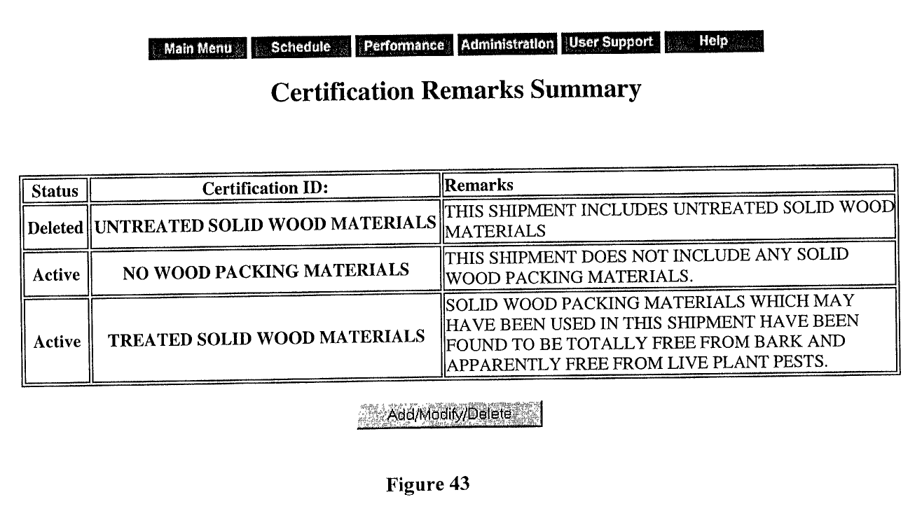

Other information available to users of the SRMS includes certification information. For example, depending on manufacturer requirements and/or state and federal regulations, suppliers may be required to provide data to a “Certification Remarks Summary” screen for certain shipments. Exemplified in FIG. 43, the “Certification Remarks Summary” screen identifies the required certification, e.g., “NO WOOD PACKING MATERIALS,” supplies remarks, e.g., “THIS SHIPMENT DOES NOT INCLUDE ANY SOLID WOOD PACKING MATERIALS,” and provides the status, e.g., Active or Deleted.

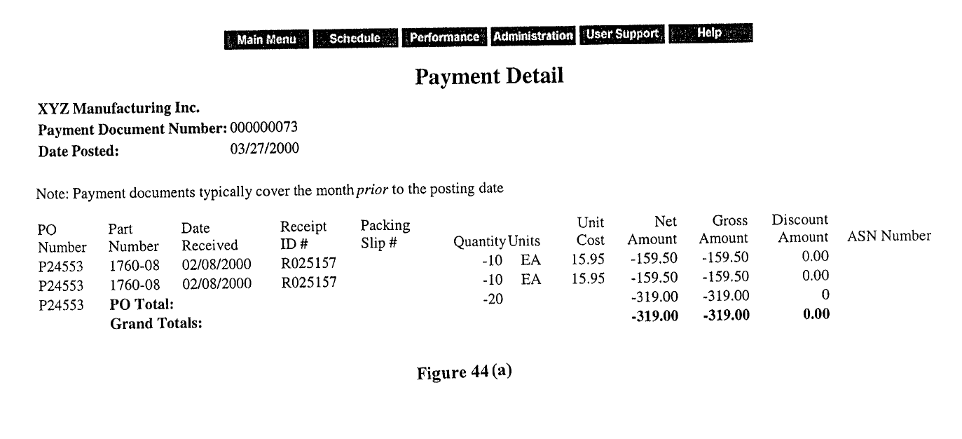

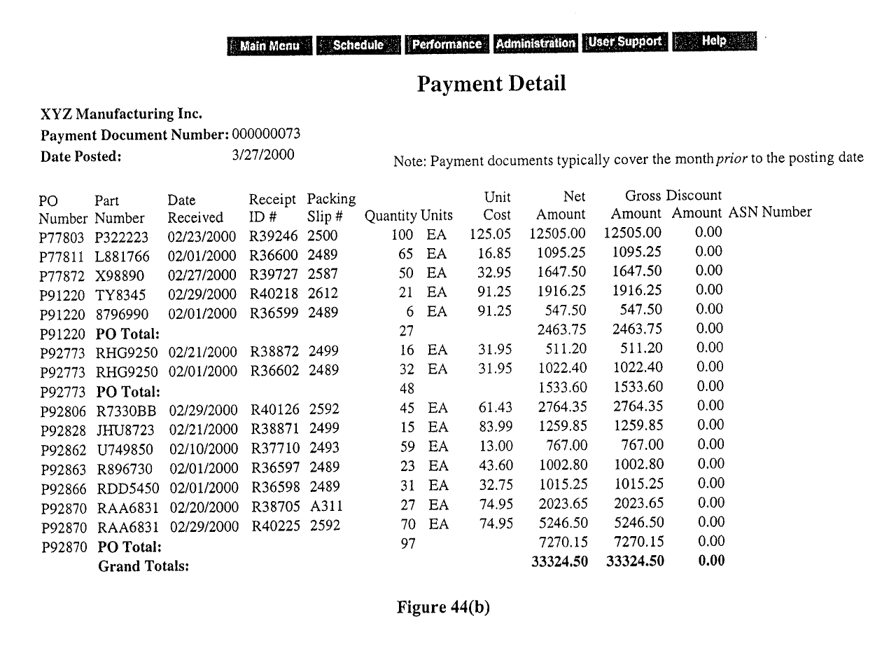

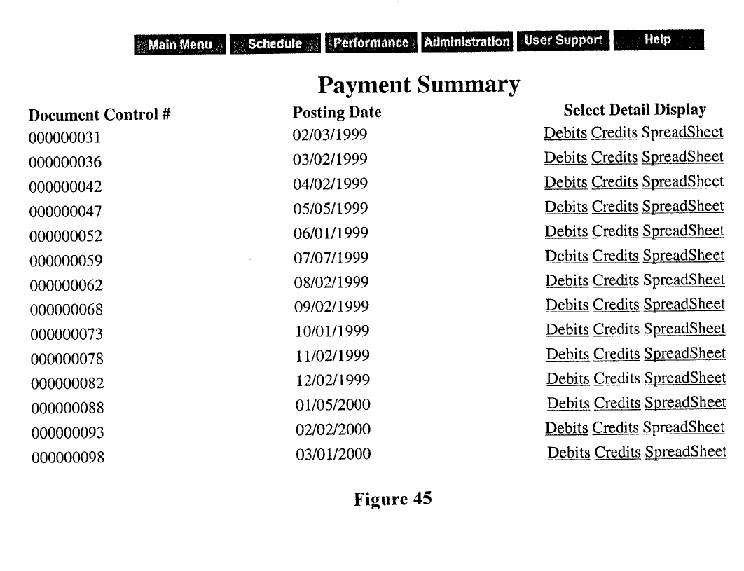

For embodiments wherein manufacturers send remittance information describing payments made to their suppliers, the SRMS provides “Payment Detail” screens FIGS. 44a and 44b, which will automatically display on the website the payment information. Through the “Payment Detail” screens, payment information can be viewed online, and it can be downloaded in “comma separated value” (CSV) format to an Excel spreadsheet or other application. It can also be printed to a local printer. The “Payment Detail” screens are accessible through links on a “Payment Summary” screen, exemplified in FIG. 45. The “Payment Summary” screen includes a listing of document control numbers, posting dates, and select detail display links, e.g., debits, credits, spreadsheet. When a user selects the “debits” link, they are linked to a “Payment Detail” screen such as that shown in FIG. 44a. Similarly, when a user selects the “credits” link, they are linked to a “Payment Detail” screen such as that shown in FIG. 44b. The “Payment Detail” screens include supplier/vendor name, a payment document number, and date posted as well as a table showing PO number, product number, date received, receipt ID number, packing slip number, quantity, units, unit cost, net amount, gross amount, discount amount, and advance ship notice (ASN) number. Further, selection of the “spreadsheet” link causes the SRMS to generate a file that can be downloaded onto a user's PC and used for input into a spreadsheet program, such as Excel.

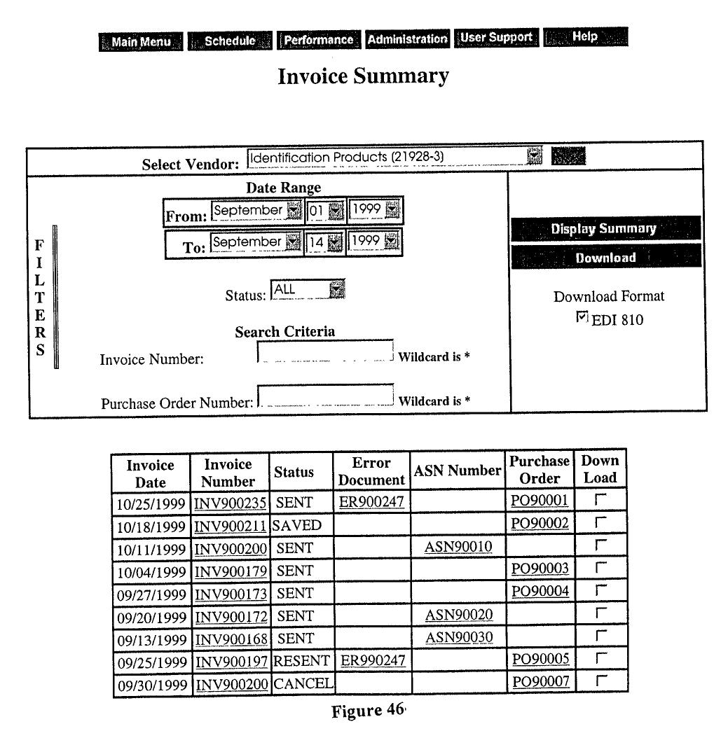

Exemplified in FIG. 46, an “Invoice Summary” screen provides users, i.e., manufacturers, with invoice information which may be filtered by supplier/vendor, date range, status, invoice number, and/or purchase order number. The invoice information provided on the “Invoice Summary” screen includes invoice date, invoice number, status (e.g., sent, not sent), error document, available to ship number, and purchase order. Further, the “Invoice Summary” screen provides a download option for a user to download selected invoice information.

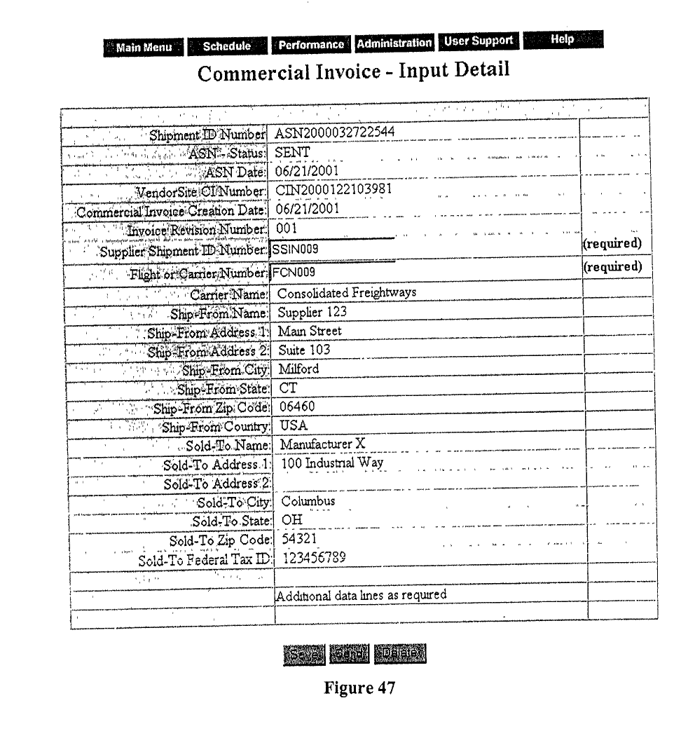

Similarly, the SRMS provides a “Commercial Invoice—Input Detail” screen that is used to create commercial invoices, e.g., by the vendor. The SRMS will automatically fill in certain of the required fields and will prompt the user for other required information. As shown in the exemplary “Commercial Invoice—Input Detail” screen of FIG. 47, the screen indicates those fields that will be automatically populated, fields that cannot be modified, and fields that require input. The SRMS automatically populates certain fields using, for example, information from the Ship Notices. On completion of the required input, the user is given the ability to, for example, save or print the Commercial Invoice. If the user chooses to print the Commercial Invoice it will automatically be saved with a status of printed. The exemplary “Commercial Invoice—Input Detail” screen includes the following fields.

Shipment ID Number: A unique number supplied by the SRMS, which will be the Advanced Ship Notice identification. Each commercial invoice has a different shipment number. This is the same number that appears on the bar-code label, and will be used for subsequent receiving and payment transactions.

ASN—Status: This is the current status of the associated ASN document.

ASN Date: The date the Advance Ship Notice was sent.

SRMS Commercial Invoice Number: SRMS assigns the Commercial Invoice number, which will be incremented by one with each new invoice created. If a user is updating or reprinting an invoice this field will be populated with the original invoice number that was previously assigned which cannot be changed.

Commercial Invoice Creation Date: A date assigned by SRMS whenever Commercial Invoice is either Saved or Finalized.

Invoice Revision Number: When a Commercial Invoice is created for the first time this field will be initialized with a value of 001. All changes made to the commercial invoice prior to sending will be associated with the original revision number. If the user selects Send and an error or update is required, the user will make the necessary changes and Send the document again which will increment the revision number sequentially. This process will insure that the new Commercial Invoice printed will match the information stored in SRMS. SRMS does not retain previous versions of a Commercial Invoice.

Supplier Shipment ID Number: A supplier assigned shipment identification number usually equivalent to the packing slip or payment invoice number.

Flight or Carrier Number: The flight number or carrier number of the aircraft or vessel in which the product is being transported.

Carrier Name: The name of the shipping company being used for transporting the product.

Ship-From Name: The name of the supplier that manufactured the product.

Ship-From Address 1: First line of the address for the supplier.

Ship-From Address 2: Second line of the address for the supplier.

Ship-From City: City where the supplier is located.

Ship-From State: State where the supplier is located.

Ship-From Zip Code: Zip Code where the supplier is located.

Sold-To Name: The name of the company paying for the goods.

Sold-To Address 1: First line of the address for the company paying for the goods.

Sold-To Address 2: Second line of the address for the company paying for the goods.

Sold-To City: City where the company paying for the goods is located.

Sold-To State: State where the company paying for the goods is located.

Sold-To Zip Code: Zip Code where the company paying for the goods is located.

Sold-To Federal Tax ID: Federal tax ID number for the company paying for the goods.

Ship-To Name: The name of the company that the goods will be delivered to.

Ship-To Address 1: First line of the address for the company receiving the goods.

Ship-To Address 2: Second line of the address for the company receiving the goods.

Ship-To City: City where the company receiving the goods is located.

Ship-To State: State where the company receiving the goods is located.

Ship-To Zip Code: Zip Code where the company receiving the goods is located.

Ship-To Federal Tax ID: Federal tax ID number of the company receiving the goods.

Dock Code: The dock or plant code to which the goods are being delivered to.

PO Number: The PO number associated with the shipment.

PO Item Number: The PO item number associated with the shipment.

PO Authorization: The PO authorization number associated with the shipment.

Broker Information: The name of the broker responsible for the Customs process of the shipment.

Port of Entry: The port in which the goods will arrive in the United States.

Harmonized Tariff Number: The tariff number associated with the shipment.

Total Net Weight of The Shipment: Total weight of the parts being shipped.

Total Gross Weight of The Shipment: Generally, the total weight after packing. This must be equal to or greater than net weight.

Country of Origin: The country where the goods were manufactured, which can be different from the country in which the goods are being imported from. This field defaults to the data on an incoming standard EDI form, e.g., form 830 or 850 record, but is modifiable upon display to allow for origins not related to the country the vendor is doing business from.

Release Status: The release status indicator provides for identifying the type of shipment that is being prepared for release. Examples for the use of this indicator are as follows, fall release with government stamp, government stamp only, partial release with government stamp, no government stamp required, partial release only or full release only. The coding scheme provides for up to four characters for identifying the shipment.

Certification Remarks: Certification remarks most often identify the materials that are used in the packaging of a shipment. However, any remarks that are specific to the certification process can be provided. SRMS provides for the selection of up to four different types of certification remarks for each invoice. This provision is managed by the group identification code associated with each set of remarks. Selection of each of the four drop down boxes labeled Certification Remarks Group 1, Group 2, Group 3, and Group 4 will provide access to the remarks associated with each of those groups. Only one selection per group is allowed. The user controls the number of groups that are utilized.

Comments: General comments about the shipment. The display provides for up to four 60-character lines of information.

Cost of Freight: The cost of freight charges incurred, if dutiable.

Insurance Costs: The cost of insurance charges incurred, if dutiable.

Commission Costs: The cost of commission charges incurred, if dutiable.

Packaging Costs: The cost of packaging materials charges incurred, if dutiable.

Port Transportation Costs: The cost of port transportation charges incurred in moving product from the carrier to the port of entry, if dutiable.

Rebates: The amount associated with any rebate offers applicable on the product, if dutiable.

Bounties: The amount associated with any bounties applicable on the product, if dutiable.

Drawbacks: The amount associated with any drawbacks applicable on the product, if dutiable.

Discounts: The amount associated with any discounts offered on the product, if dutiable.

Unit Assist Value(s): The assist value(s) associated with any production aids provided in the manufacture of the product. This can include assists in the form of dies, molds, tooling, printing plates, artwork, engineering work, design and development, financial assistance, etc.

Flex 1 (Master Airway Bill Number): A configurable flex field that the manufacturer can use to display or enter additional information.

Flex 2 (House Bill Number): A configurable flex field that the manufacturer can use to display or enter additional information.

Flex 3 (Contract Code Number): A configurable flex field that the manufacturer can use to display or enter additional information.

Flex 4 (Inco Terms): A configurable flex field that the manufacturer can use to display or enter additional information.

Flex 5 (Exhibit Code): A configurable flex field that the manufacturer can use to display or enter additional information.

Flex 6 (Order Call Number): A configurable flex field that the manufacturer can use to display or enter additional information.

Default Shipper's Name: Name of the person preparing the Commercial Invoice/Packing Slip. Defaults to the person's logon.

The “Commercial Invoice—Input Detail” screen also allows the user to “Save” which saves the commercial invoice to the SRMS database, but allows the user to return to complete or modify the invoice prior to finalization; “Send” which activates customer defined validation requirements, completes the commercial invoice for use in accompanying product shipments through customs, and launches an outbound data feed to prepare and send the data to the manufacturer; “Delete” which removes previously entered input; and “Display Printout” which displays the commercial invoice in a standard web browser window format that can be printed. If the commercial invoice has been saved, a watermark or title change will be used to show the document is in draft or preliminary format. If the commercial invoice has been sent, the document will be in a format suitable for accompanying the products through the import process.

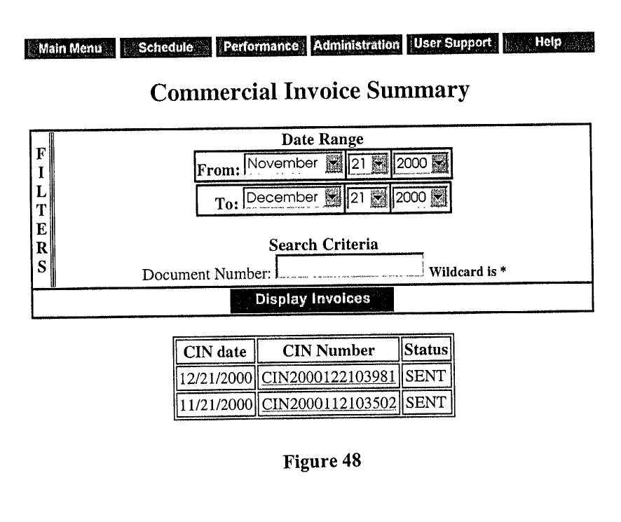

An exemplary “Commercial Invoice Summary” screen is shown in FIG. 48, which summarizes the commercial invoices created by a supplier filtered by date range and/or document number and displayed in summary form according to date, number, and status, e.g., sent or not sent.

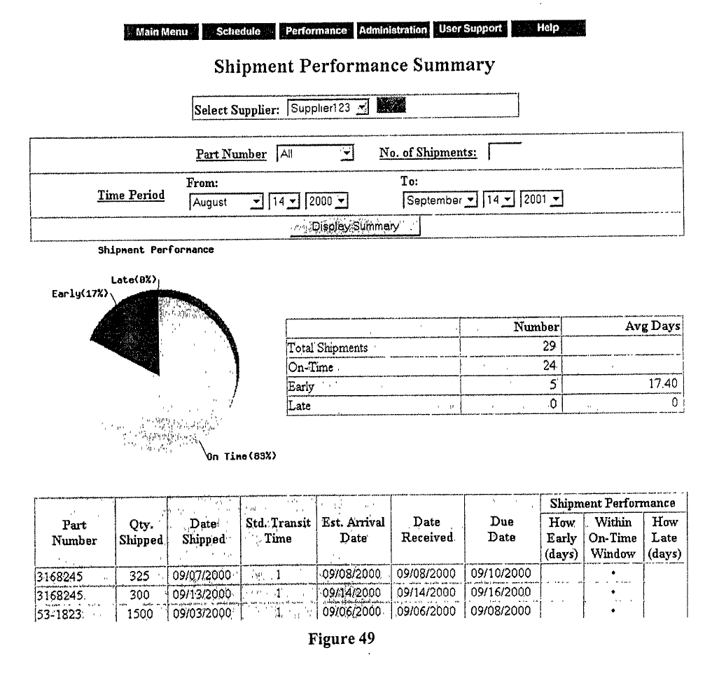

In an embodiment of the present invention, the SRMS generates reports on each supplier's performance in meeting product shipment requirements. These shipment performance reports are summarized in a “Shipment Performance Summary” screen, exemplified in FIG. 49. The “Shipment Performance Summary” screen allows manufacturers to analyze why a vendor's performance is low or high. The data present in the “Shipment Performance Summary” screen measures how well a selected vendor is performing in shipping materials in order for them to arrive at a designated manufacturer location at the required time. The “Shipment Performance Summary” screen is selected from a link on the Main Menu or a link on the Navigation Bar at the top of each SRMS screen. The “Shipment Performance Summary” screen is available to users at all access levels. A user at vendor level access can only view data for their own performance. A user at the Buyer/Planner or Administrator access level may view the Shipment Performance of any supplier. The selection fields at the top of the “Shipment Performance Summary” screen allow the user to select the content of the data to be displayed. Selection criteria include: part number which allows the user to view shipment performance information on “All Parts” or any individual part number; date range over which start and end periods shipment performance information is displayed; and number of shipments which is the number of shipments over which shipment performance information will be displayed. The date range defaults to one calendar month from today's date. The user may then change the date range and select the DISPLAY SUMMARY button to present data for the new range. If both a date range is selected and a number of shipments is entered, the performance calculation will be made over the greater number of shipments covered by the two criteria.

Data are presented on the number and percent of shipments made on time, early, and late as well as such items as average days early/late and detail on each shipment made. More detailed information shown on the “Shipment Performance Summary” screen includes product number, quantity shipped, date shipped, standard transit time, estimated arrival date, due date, and performance (e.g., how early, on time, how late). Supplier performance metrics are provided real time to allow for immediate tracking of on-time, early and late arrivals of shipments and of overall supplier performance. Measurements can be calculated against the required ship date, the dock due date or any other SRMS stored date (e.g., supplier commit date). Further exemplary information regarding the “Shipment Performance Summary” screen is found in Provisional Application Nos. 60/213,324 and 60/250,507 both entitled “Method and System for Supply Chain Management” and incorporated herein by reference in their entirety.

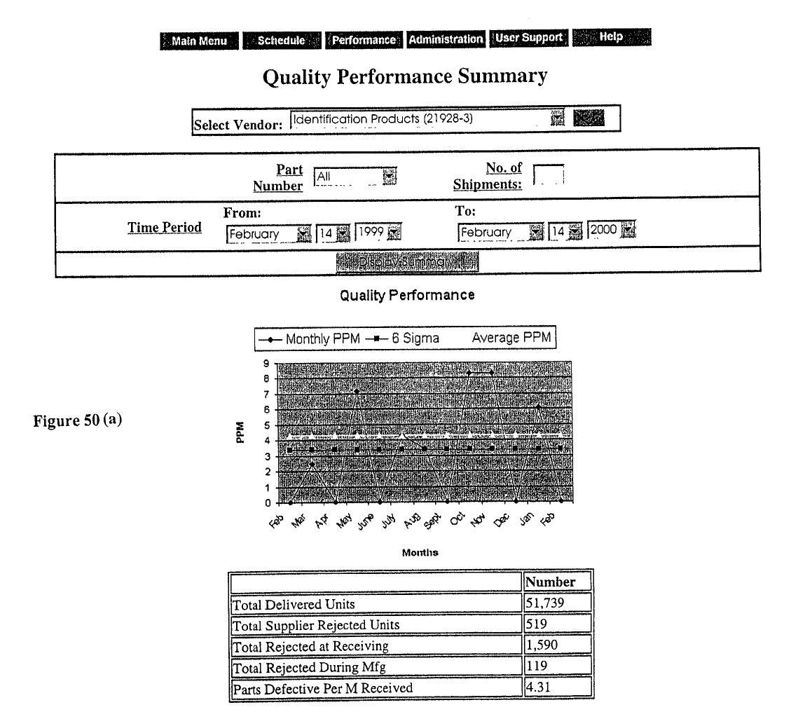

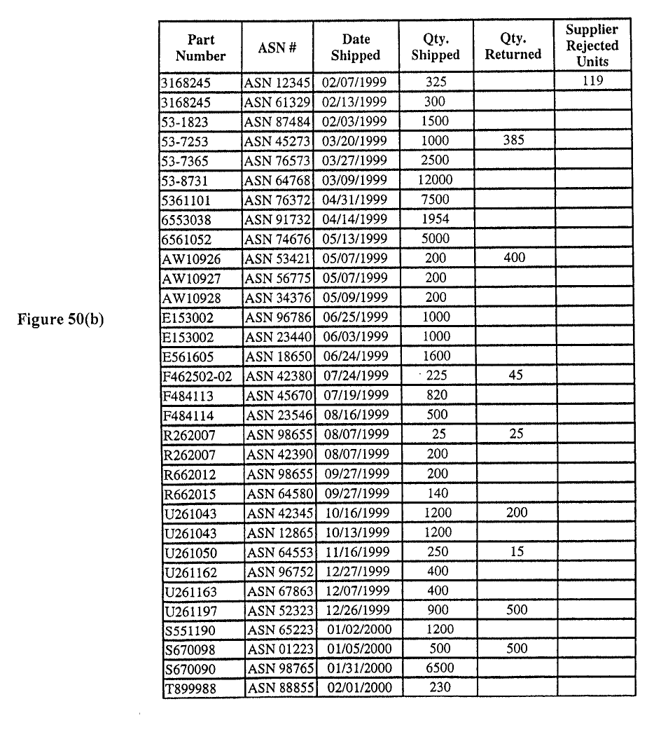

In an embodiment of the present invention, the SRMS also generates reports on each supplier's performance in meeting product and/or service quality expectations. These quality performance reports are summarized in a “Quality Performance Summary” screen, exemplified in FIGS. 50a and 50b. In FIG. 50a, the user selects from the following parameters to formulate a report supplier/vendor, product, number of shipments, and/or time period. The quality performance information includes: a graph of months versus PPM showing monthly PPM, 6 sigma, and average PPM; a first table listing total delivered units, total supplier rejected units, total rejected at receiving, total rejected during manufacturing, products defective per million received; and a table listing product number, advance ship notice number, date shipped, quantity shipped, quantity returned, and supplier rejected units.

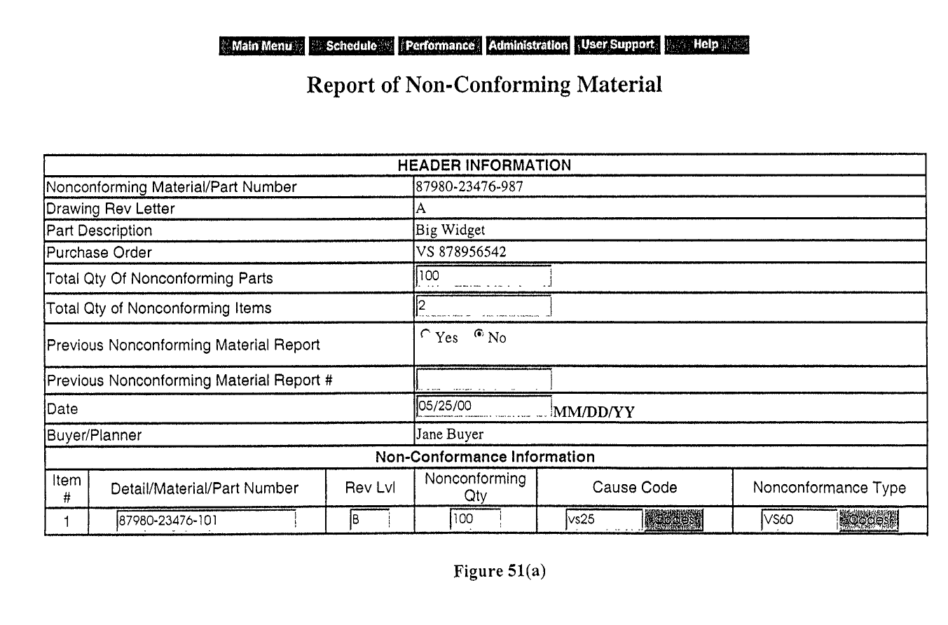

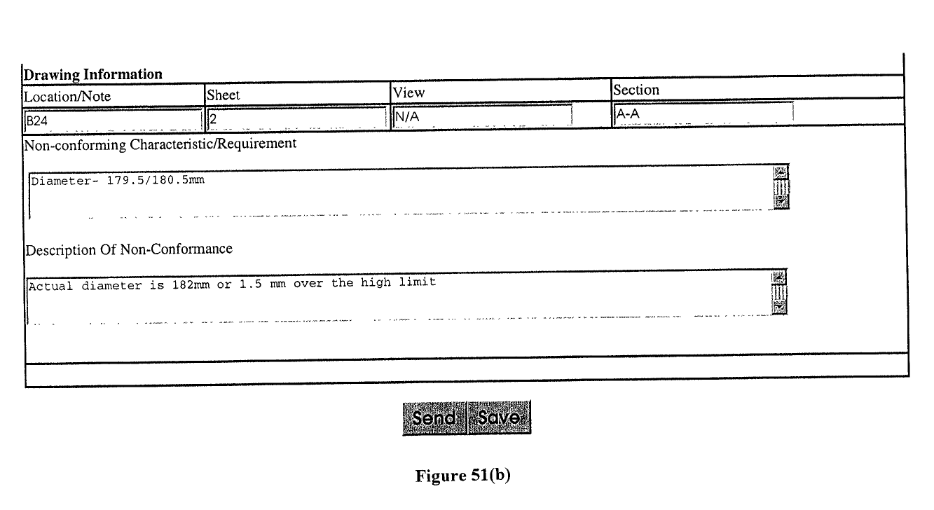

At least one data source for the “Quality Performance Summary” screens are the “Report of Non-Conforming Material” screens generated by the users. Exemplified in FIGS. 51a and 51b, the “Report of Non-Conforming Material” screens include header information such as nonconforming material/product number, drawing revision letter, product description, purchase order number, total quantity of non-conforming products, total quantity of non-conforming items, previous non-conforming material report, existence thereof and reference number, date, and manufacturer buyer/planner name. The “Report of Non-Conforming Material” screens also include detailed non-conformance information such as item number, product number, revision level, non-conforming quantity, cause code, and non-conformance type. Further, in order to illustrate more completely the non-conformance, drawing locations, sheets, views, and sections are provided, in addition to a description of the non-conformance, if available. For example, in FIG. 51b, the actual diameter of the exemplary non-conforming product is over the specified height limit.

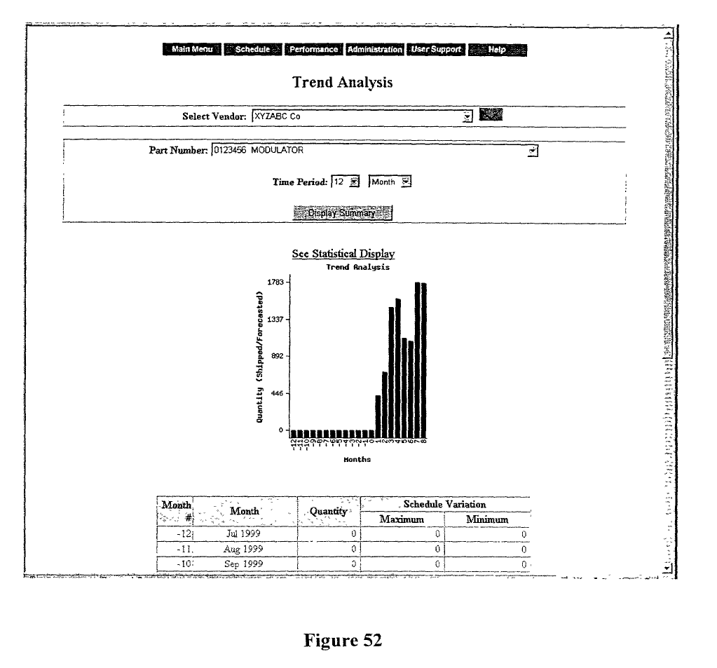

In a preferred embodiment of the present invention, users have access to a product and/or service usage, “Trend Analysis” screen exemplified in FIG. 52 for both historical and planned items. The usage for a selected product and/or service is graphically represented for a specified window of time (e.g., 24 months total, twelve months prior and twelve months into the future), followed by details for each month. The details include specified months within the window of time, quantity within the specified month, and schedule variations (e.g., minimum and maximum). The schedule variation maximum is a measurement of the largest quantity of a specific part that has been forecast by the manufacturer to be delivered in each displayed time period (e.g.; month of November, week of July 25). The schedule variation minimum is the smallest such quantity. For example, if in FIG. 24 for the month of July the “Quantity” (this is the quantity actually delivered or presently forecast to be delivered) is 200, the Schedule Variation Maximum is 400 and the Schedule Variation Minimum is 100 this means that, over the history of all schedule information received by the SRMS for this part, the maximum quantity ever forecast to be delivered in the month of July was 400 and the minimum quantity ever forecast was 100.

Referenced above with respect to certain processes and functions, the SRMS provides event driven messaging capability in the form of e-mail messaging. In certain embodiments of the present invention, e-mails are configured so that messages about an event are sent to both the manufacturer and the supplier. Further, suppliers are notified via e-mail of the SRMS receipt of documents (e.g., “Planning Schedule”, “Shipment Trigger”) from the manufacturer. In still other embodiments, the e-mail messages contain at least one URL link to an associated screen within the SRMS. More particularly, examples of the e-mail alerts sent by the SRMS are detailed below.

A new schedule advisory e-mail is sent to selected users at the supplier, and the appropriate manufacturer personnel when the SRMS receives new planning schedule information that has new or changed items on it for a supplier. The text of the message will contain the date of the new schedule and a notice that it has new or changed items that may require their attention. It will in addition have a hot link to the SRMS. For example:

| | |
|---|---|
| Subject: | VendorSite Alert (“Customer Name”) - New Schedule Advisory |
| Date: | Mon, 10 Apr 2000 15:10:23 −0400 (EDT) |
| From: | vshelp-“Customer Name”@eventra.com |
| To: | paulwl@eventra.com |
| CC: | vshelp-“Customer Name” |

------------------------------------------------------------------------------------------
VendorSite Alert (“Customer Name”) - New Schedule Advisory
------------------------------------------------------------------------------------------
Dear “SUPPLIER NAME”:
VendorSite has just installed a new “Customer Name” planning schedule,
dated 05-APR-2000.
It appears that your schedule has new or changed items that may
require your attention.
VendorSite: http://www.vendorsite.com

A planning schedule problem e-mail is sent to selected users at the supplier and the appropriate manufacturer personnel when the SRMS receives new planning schedule information that is problematic from the business or information technology point of view.

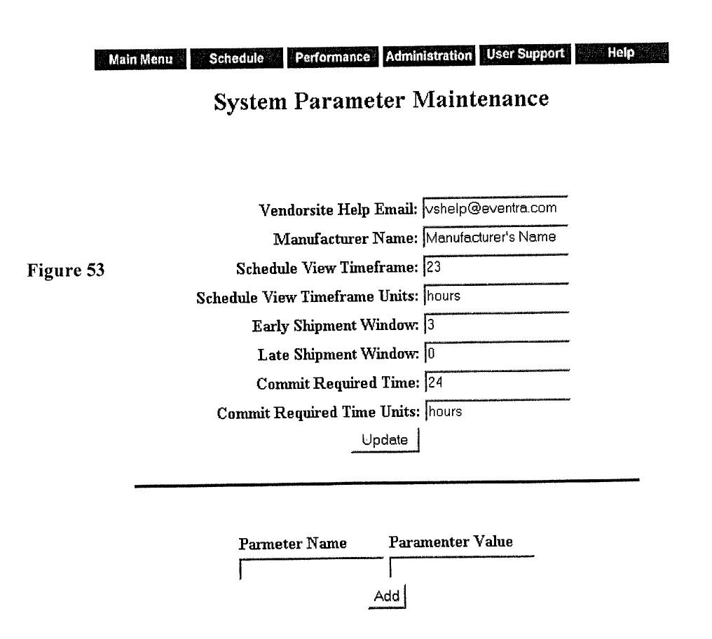

A schedule not viewed e-mail is sent to selected users at the supplier and appropriate manufacturer personnel if the supplier does not log-on to the SRMS and call up the “Schedule Summary” screen within a certain period of time after a new schedule advisory e-mail has been sent. The period of time is configurable within the SRMS system via the “System Parameters Maintenance” screen FIG. 53 which is accessible by at least the SRMS administrator.

A late shipment e-mail alerts selected users at the supplier and appropriate manufacturer personnel that a ship notice has not been sent by the supplier for products that should have been shipped today in order for them to arrive on the manufacturer's due date. The e-mail message text includes the schedule item(s) that should have been shipped and a hot-link to the “Schedule Summary” screen.

A firm order exception alert e-mail is sent to selected users at the supplier and to appropriate manufacturer personnel if the supplier has indicated any exceptions (either date or quantity) to “FIRM” items on the planning schedule. The e-mail message text will indicate the date of the planning schedule and the schedule commit and will list all of the schedule items to which an exception was taken. It will also display the contents of any note fields that were filled in on the “Schedule Commit” display. The message will contain a hot link to the “Schedule Summary” screen that is filtered to show only schedule exceptions. Similarly, a planned order exception e-mail message is sent under identical circumstances to the firm order exception e-mail except that it lists all exceptions taken to “PLANNED” items.

A “schedule commit not sent” e-mail is sent to selected users at the supplier and the appropriate manufacturer personnel if a supplier does not respond to a new planning schedule by executing the “Commit” process within a configurable period of time after the schedule is received (e.g., 24 hours). The e-mail message text will indicate the date of the planning schedule and the time period that has elapsed since it was received. The message will also contain a hot link to the “Schedule Summary” display. The period of time is configurable within the SRMS system via the “System Parameters Maintenance” screen which is accessible by at least the SRMS administrator.

A “document receipt advisory” e-mail is sent to selected users at the supplier and the appropriate manufacturer personnel upon receipt of documents from the Manufacturer. Where appropriate, the e-mail message will contain a URL link to an associated screen within VendorSite.

An “application advice” e-mail is sent to selected users at the supplier alerting them that an Application Advice document has been received from the Manufacturer. The Application Advice document informs the Supplier that a document or documents from the Supplier is/are rejected or accepted with errors or have some other sort of advisement from the Manufacturer system. The e-mail message text will indicate the documents and error codes referenced in the Application Advice. Furthermore, there is in the e-mail a hot link to the Application Advice Summary display.

A “purchase order acknowledgement” e-mail is sent to the appropriate manufacturer personnel whenever a supplier sends a PO Acknowledgement document to the Manufacturer that has a status other than “Accepted”.

Finally, the SRMS allows for administrators of the system to send global email messages to suppliers, manufacturing personnel and administrators. In an embodiment of the present invention, this is accomplished through a system driven e-mail loop such that each e-mail created is addressed to only one system user to prevent users from obtaining identification of other users that may be on the system.

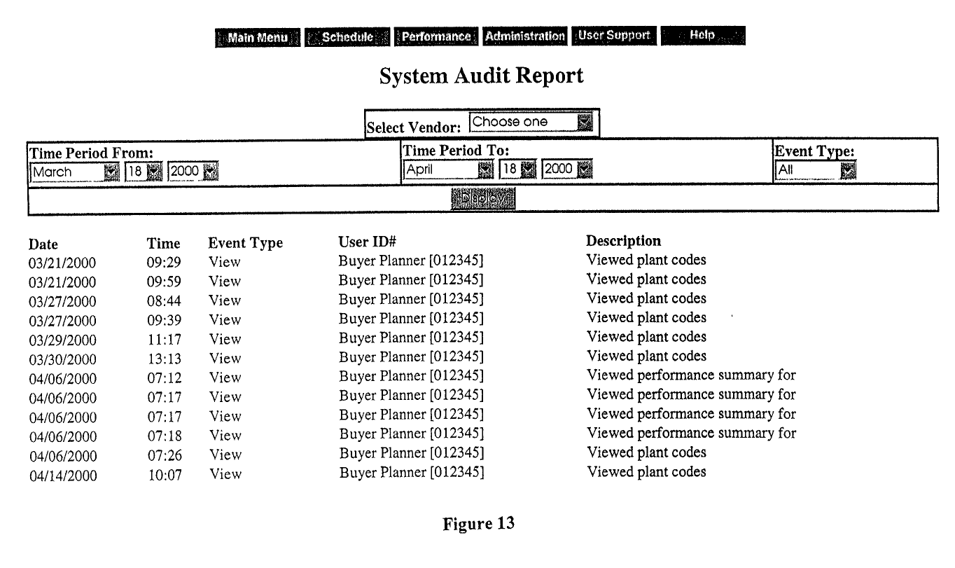

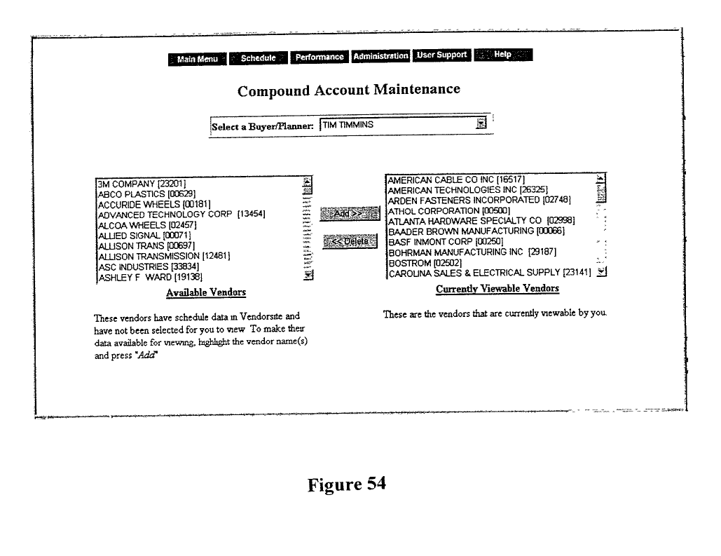

In certain embodiments of the present invention, there are other administrative Webpages available to users of the SRMS. For example, “Compound Account” screens, exemplified in FIG. 54 allows appropriate manufacturer personnel to configure the list of suppliers that will appear in the manufacturer personnel's supplier drop down selection lists. It also allows the manufacturer to configure a supplier that has more than one supplier ID number with a single account that contains data for both accounts. The SRMS also maintains a system log of all significant events such as documents and e-mail messages sent and received, logons, etc. The “System Audit” log may be viewed via the “System Audit” screen, exemplified in FIG. 13. Further, the SRMS maintains configurable numbers of months of summary data and of detail data on-line. All other data is archived. Archived data is retrievable by contacting the SRMS administrator and requesting that selected archive data be loaded into the database.

In alternative embodiments of the present invention, the SRMS provides functions which allow users to individually configure various aspects of the SRMS to meet the needs of individual users.

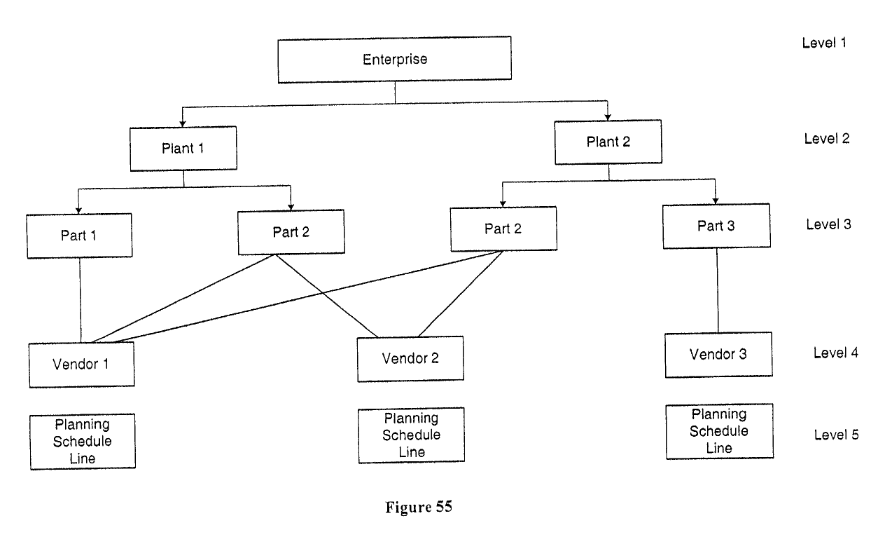

The SRMS establishes an information hierarchy (“IH”) within the SRMS that enables functionality to be defined at any one of five levels. Referring to FIG. 55, in a preferred embodiment of the present invention, level 1 represents the enterprise (the manufacturer), level 2 includes the plant or manufacturing facilities, level 3 includes the products and/or services, level 4 includes the suppliers/vendors, and level 5 includes the planning schedule line items.

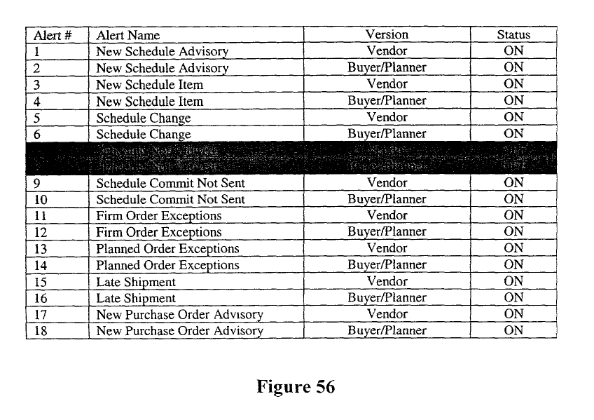

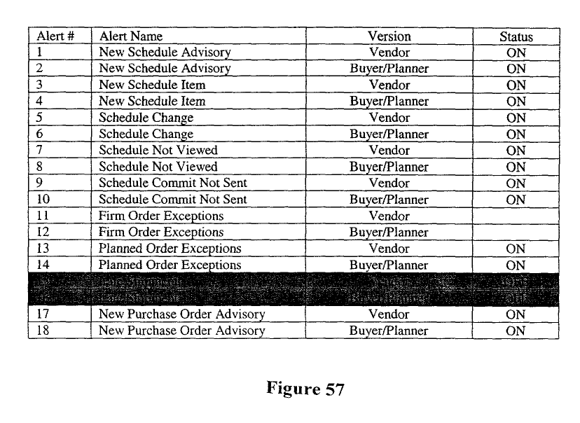

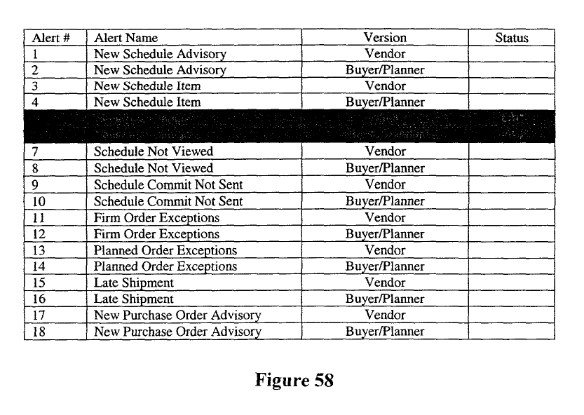

In a further preferred embodiment of the present invention, the SRMS IH is used to control the transmission of e-mails using varying levels of granularity through defaults and overrides. The SRMS e-mail messages described herein fall into the following categories: e-mail alerts which are automatically generated by the SRMS to alert various SRMS users about supply chain conditions which need their immediate attention; e-mail broadcasts which are manually generated by a user with administrator access privileges which are sent to selected groups of the SRMS users; and individual e-mail messages that are sent from an individual SRMS user to another user, for instance, from a supplier to a buyer/planner. The SRMS allows for e-mail messaging to be turned on or off for selected messages via a configuration screen. Further, each “e-mail alert” message can be configured to be activated (sent) or inactivated (not sent) in several ways, configurable globally, and also by manufacturer, by plant/facility, by part/supplier, and/or by user (e.g., supplier, buyer/planner). Referring to FIGS. 56-58, e-mails alerts are selectively labeled as “ON” or “OFF.” In the e-mail IH, the global 1 e-mail configuration shown in FIG. 56 has the lowest priority within the hierarchy. Consequently, even though in FIG. 56, e-mail alerts 7 and 8 are turned “OFF,” if these same alerts are turned “ON” in both level 2 and level 3, these alerts will be transmitted accordingly. Similarly, any status configurations set in the plant/facility Level 2 e-mail configuration exemplified in FIG. 57 are overridden by configurations set in the part/supplier Level 3 e-mail configuration exemplified in FIG. 58. As such, considering the exemplary configurations set forth in FIGS. 56-58, alerts 7 and 8 will be viewed at Level 2 and Level 3, alerts 15 and 16 will not be viewed at a specific plant/facility level, and alerts 5 and 6 will not be viewed at a specific part/supplier level. Blanks in the status column mean that the previous level's status applies.

In another embodiment of the present invention, another functionality in the SRMS that is configurable using the IH is the number of days early a product may be received by a manufacturer and considered as an on time delivery. This functionality attribute controls when the schedule line in the “Schedule Summary” screen opens the ship quantity box for a shipment release mechanism based on an automatic time window. The days early (“DE”) functionality attribute may be defined (controlled) at any one of the levels as follows. Utilizing the level settings from FIG. 55, setting the DE functionality attribute at Level 1, for the enterprise, defines the value for all plants, all products, and all suppliers. This makes the DE constant through the SRMS, and is considered the default value. Setting the DE functionality attribute at Level 2, for a plant/facility, defines the value for all products and suppliers that supply that plant, across each planning schedule line. This allows a manufacturer to define a DE value for one plant where, for example, there may be a larger storage area for material than at a second plant which has limited storage capacity. Setting the DE functionality attribute at Level 3, for a product defines the value across all suppliers and planning schedule lines. This allows a manufacturer to define the DE value for a particular product which, for example, may be very expensive, thus reducing the number of days that the part is allowed to sit idle within the plant verses bulk material which is used to replenish floor stock. Setting the DE functionality attribute at Level 4, for a supplier/vendor, defines the value a specific supplier/vendor across all planning schedule lines. This allows a manufacturer the ability to define a DE value for one supplier where, for example, the transit time has a large variation possibly an overseas supplier subject to customs workload verses domestic suppliers. Finally, setting the DE functionality attribute at Level 4, for a planning schedule line, defines the value a specific planning schedule line. This allows a manufacturer the ability to define a DE value for a single delivery where, for example, a manufacturer inspection needs to be performed and the supplier is allowed to ship the product as soon as it is ready by setting the DE value to 1000.

In an alternative embodiment, the SRMS is configured to manage and consolidate the schedules of multiple manufacturers for the benefit of individual suppliers/vendors. More often than not, a single supplier/vendor is responsible for providing products and/or services to multiple manufacturers. In the same way that the SRMS simplifies and manages the supply chain from the manufacturers perspective, suppliers/vendors will also benefit from the consolidation if information about the manufacturers they are servicing. The SRMS provides searchable information and summary screens to suppliers/vendors containing data for multiple manufacturers. These information and summary screens are dynamic in that they provide the supplier/vendor with filters in order to single out desired data. These filters allow users to narrow according to manufacturer, product and/or service, delivery dates, end-product due dates, etc.

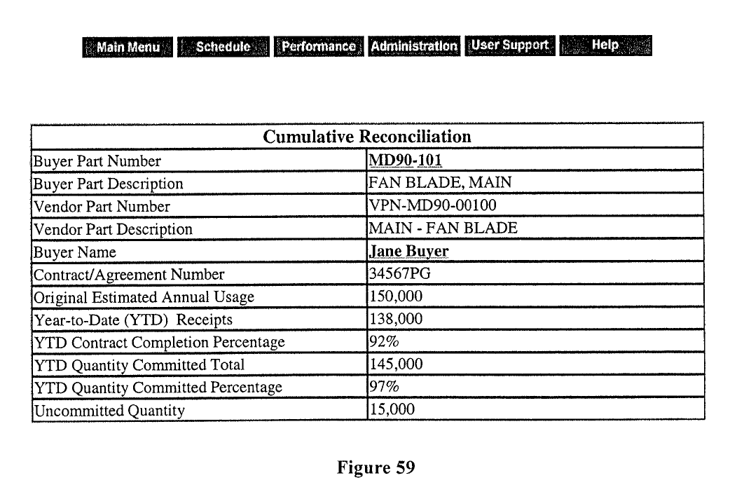

Other SRMS features available to users, particularly suppliers, is the “Cumulative Reconciliation” screen, exemplified in FIG. 59. The SRMS is configured to track the cumulative consumption of materials by one or more manufacturers. This information allows suppliers/vendors to track the consumption needs of manufacturers. This information is useful both from a short and long term perspectives. In the short term this information serves to, for example, warn the supplier/vendor of an upcoming increase in demand of a particular product and/or service. In the long term, the supplier/vendor is able to track the consumption habits of the manufacturers in order to tailor its needs accordingly. By way of example, this information may be particularly beneficial to the supplier who is also a manufacturer, commonly referred to as the middleman. Referring to the exemplary “Bills of Sourcing Hierarchy” screen of FIG. 20, these are the Tier 2 suppliers/vendors who receive and transform raw materials from a company. The exemplary “Cumulative Reconciliation” screen includes information such as product number (both supplier and manufacturer if different), product description (both supplier and manufacturer if different), manufacturer name or other identifying information, contract/agreement number, original estimated annual usage, year-to-date (YTD) receipts, YTD contract completion percentage, YTD quantity committed total, YTD quantity committed percentage, and uncommitted quantity. One skilled in the art recognizes that there are many variations available for the information listed in the “Cumulative Reconciliation” screen, for example, the time measurement need not be years (e.g., could be months, total project length, etc.). Further, the supplier may set-up, e.g., an e-mail or log-on alert based on one of the parameters listed on the “Cumulative Reconciliation” screen. For example, the supplier may request via a supplier set-up screen (not shown) that a log-on alert be sent when the YTD contract completion percentage (e.g., 95%) is reached for a certain product and manufacturer.

The “Cumulative Reconciliation” screen information is also useful for verifying the transit time of shipped items and for making corrections accordingly. By comparing the cumulative quantities received to the cumulative quantities shipped, the measured transit time can be compared to the assumption for transit time and either the expected transit time or the method for transit or the supplier, if necessary, may be adjusted accordingly. In the alternative embodiment wherein discrete quantities received are reported to the SRMS, rather than cumulative values, the SRMS will store and accumulate these discrete values, then display the resulting cumulative quantities received at a later time.

In alternative embodiments of the present invention, the SRMS is implemented in a flexible manner, to allow the system to: (1) aggregate the schedule requirements of several manufacturers for a particular supplier; (2) extend the above aggregation capabilities to the embodiment in which organization A supplies organization B which supplies organization C, such that B has both the manufacturer and supplier roles; (3) extend the above aggregation capabilities to the case in which organization A supplies organization B which, directly or indirectly, supplies organization A, such that each organization in the supply loop has both the manufacturer and supplier roles; and (4) extend the above capabilities to provide additional services to the SRMS users, such as, with appropriate permissions, allowing manufacturer A to view manufacturer B's evaluations of supplier C.

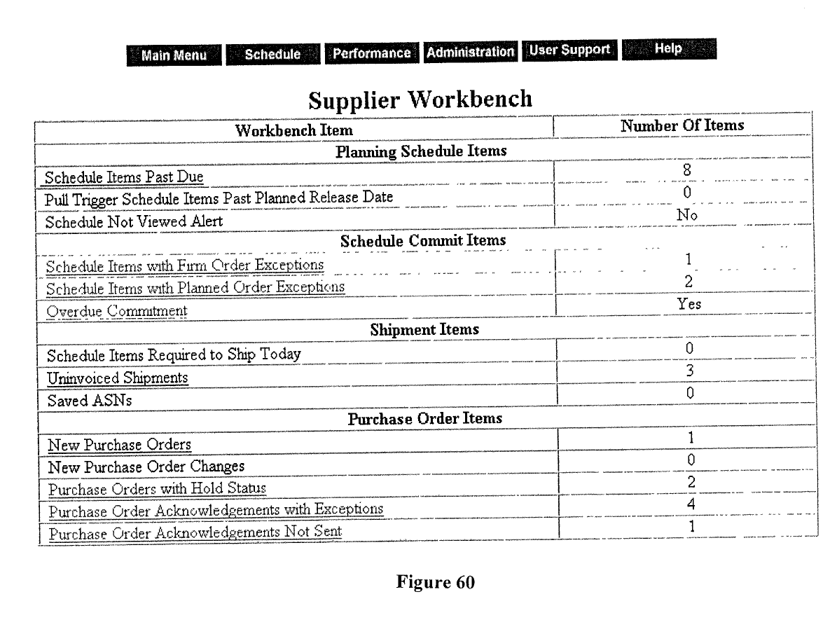

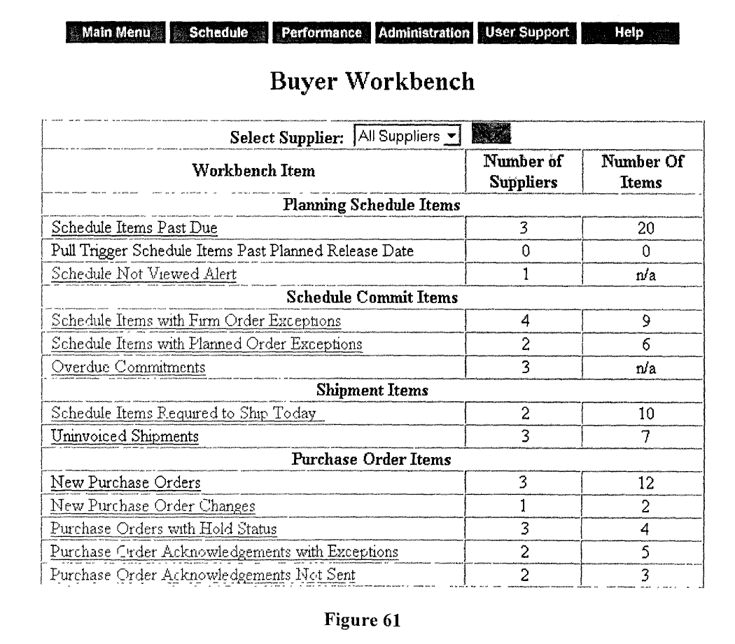

The SRMS provides “Buyer Workbench” and “Supplier Workbench” displays that each contain the same list of workbench items with the exception of the number of “Saved ASNs” which is only found in the “Supplier Workbench” display. The “Supplier Workbench” exemplified in FIG. 60, displays a list of workbench items and the number of occurrences of each item for this supplier. The “Buyer Workbench” exemplified in FIG. 61 displays a list of workbench items, the number of suppliers that have an occurrence of this item, and the total number of occurrences of each item for all suppliers in the Buyers supplier list. The following describes examples of the workbench items present in the displays.

Schedule Items Past Due: This row displays the total number of Past Due Schedule Items in the Schedule Summary.

Pull Trigger Schedule Items Past Planned Release Dates: This row displays the total number of Schedule Items in the Schedule Summary which are “Pull Trigger” type and whose Due Date is earlier than today. This is designed to show the user the number of Pull Trigger items that were expected to have shipped by today but for which a Material Release has not been received.

Schedule Not Viewed Alert: This is a flag that gets set to “Yes” when a “Schedule Not Viewed” Alert is generated for that supplier and is reset to “No” after any user from that supplier logs on to the SRMS and views the “Schedule Summary” display.

Schedule Items With Firm Order Exceptions: This row displays the total number of Commit exceptions to Firm orders as shown in the “Schedule Summary.”

Schedule Items With Planned Order Exceptions: This row displays the total number of Commit exceptions to Planned orders as shown in the Schedule Summary.

Overdue Commitment: This row shows a flag that gets set to “Yes” when the supplier has an overdue commitment. This occurs when the supplier has received new schedule items and has not responded with a Commit within the required period of time.

Schedule Items required to Ship Today: This row displays the total number of Schedule Items in the “Schedule Summary” whose Required Ship Date is equal to today.

Uninvoiced Shipments: This row displays the total number of ASNs for which Invoices have not been sent.

Saved ASNs (Supplier Workbench Only): This row displays the total number of saved ASNs.

New Purchase Orders: This row displays the total number of Purchase Orders (“POs”) with a status of New. A New status means the PO has been received but has not yet been viewed by any user.

New Purchase Order Changes: This row displays the total number of Purchase Order Changes (“POCs”) with a status of New. A New status means the POC has been received but has not yet been viewed by any user.

Purchase Orders with Hold Status: This row displays the total number of POs and POCs with a status of Hold.

Purchase Order Acknowledgements with Exceptions: This row displays the total number PO and POC acknowledgements with exceptions. An acknowledgement with exceptions is any PO Acknowledgement type other than “Accepted”.

Purchase Order Acknowledgements Not Sent: This row displays the total number POs and POCs received for which acknowledgements have not been returned.

The Buyer and Supplier Workbench screens provides a user with a type of “to-do” list and prompting for items that need attention. In addition to the screens themselves, in another embodiment of the present invention, the SRMS includes a module that commands a reminder “pop-up” window to appear either on command or on specific user actions. For example, in a specific embodiment, a to-do list appears on log-on. The pop-up to-do list is in the form of the workbench display or some variation thereof.

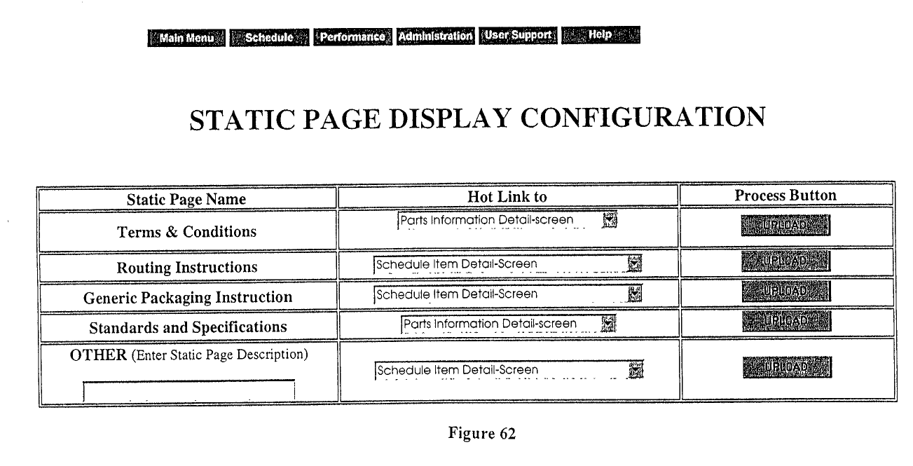

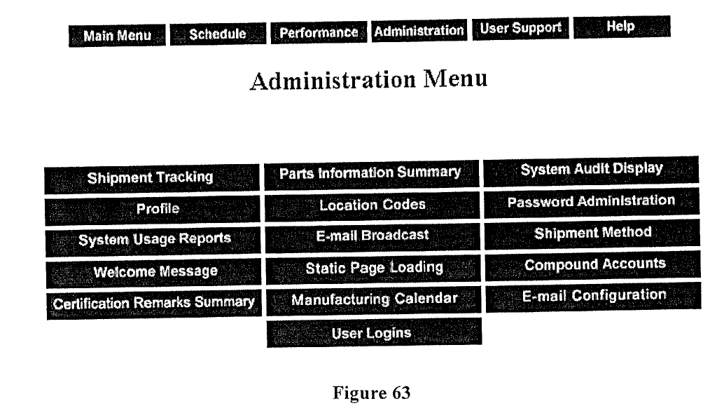

The SRMS further provides a “Static Page Display Configuration” screen, exemplified in FIG. 62, that provides the manufacturer, through static page loading, with the ability to load standard contractual and informational documents into the SRMS. These documents can then be accessed by the vendor through any number of pre-determined hot links provided on the SRMS screens. The “Static Page Display Configuration” screen provides a system administrator with the ability to upload applicable documents, e.g., Microsoft Word documents, and activate a variety of predetermined hot-links through which a vendor could access the subject documents. The “Static Page Display Configuration” screen is accessed through a link on the “Administration Menu” screen, exemplified at FIG. 63.

An embodiment of the SRMS system includes inventory management through buffer zone tracking. Some manufacturers require suppliers to maintain a safety stock of inventory at the supplier facilities, which can be immediately shipped to support changes in production. This safety stock inventory is called a buffer zone. Buffer zone requirements give the supplier the ability to view the required buffer zone or quantity of parts that they must keep on hand. The contract administrator or the buyer establishes the buffer zone requirement. The supplier is required to keep at least the buffer zone requirement on-hand for immediate shipment to a manufacturer's location. Various SRMS screens, such as the “Schedule Summary” screen provide the environment for both the buyer and the supplier to enter and manage data as it relates to the buffer zone requirement.

A further embodiment of the SRMS system includes the ability to process both scheduled and non-scheduled purchase order items for both direct and indirect materials. Referring to Table 1 below, the processing rules for Indirect items include generally for an embodiment of the present invention: an item on a “Planning Schedule” or a “Purchase Order” that has all three of the following attributes; (1) a Part Number, (2) a Date (either Dock Due Date or Required Ship Date), and (3) a Quantity is considered a Schedule Item and these items are processed into the Schedule Item Table (SIT) and displayed on the “Schedule Summary” and other related displays; items that have a Part Number and Date but not a Quantity are assumed to have a quantity of one (1) and are processed in the same manner as the above; items that have a Part Number but no date or quantity are considered non-scheduled items and cannot be processed into the SIT, these items are visible on the PO only, and they are not displayed on the Schedule Summary display; the PO Summary display shows whether or not there are any non-scheduled items on each PO; any item received in a Purchase Order or a Planning Schedule that does not have a Buyer Part Number (a Non-Part-Number item) is considered as an indirect material item and is also processed as described in the paragraph above; non-part-number items that have a schedule associated with them have the schedule visible via a button on the PO screen; a non-part-number item is considered to have a schedule when the item has quantities and dates associated with one or more deliveries; and if the item has a date but no quantity, a quantity of one (1) is assumed.

TABLE 1
Indirect Material Item Processing Matrix

| | | | PS/PO Line Processing | | | | |
|---|---|---|---|---|---|---|---|
| PS/PO Line Characteristics | | | | Add to | Display on | Update | Late |
| Part | | | Quantity | Schedule Item | Schedule | Parts | Shipment |
| Number | Date | Quantity | Insert | Table | Summary | Database | Alerts |
| Yes | Yes | Yes | No | Yes | Yes | Yes | Yes |
| Yes | Yes | No | Insert Qty = 1 | Yes | Yes | Yes | Yes |
| Yes | No | Yes | No | No | No | Yes | No |
| Yes | No | No | No | No | No | Yes | No |
| No | Yes | Yes | No | Yes | No | No | No |
| No | Yes | No | Insert Qty = 1 | Yes | No | No | No |
| No | No | Yes | No | No | No | No | No |
| No | No | No | No | No | No | No | No |

In a further embodiment of the present invention, the SRMS adds received material information, such as material receipt data from the ERP/MRP system of a manufacturer. This information may be in the form of a discrete quantity received or a cumulative quantity received in an appropriate format, e.g., EDI format. The SRMS processes the data and posts it to the Schedule Item Table (SIT) in a SRMS data base. Common EDI documents supported are the 861 and 830. The EDI 861 is a discrete quantity receipt document. EDI 861 supports discrete quantities, however, other file transfer formats (i.e. XML) support cumulative quantities. The EDI 830 document may be configured as either a discrete quantity receipt or a cumulative quantity receipt document. Flat files may be received using standard File Transfer Protocol (“FTP”) and mapped into the system from legacy systems or proprietary receiving systems.

In a further embodiment of the present invention, the SRMS maintains a record of vendor lead time feedback, wherein lead time is measured from order to delivery of the item(s). This functionality is particularly useful for, for example, manufacturers whose business process requires their vendors to provide distinct lead time values in addition to the total lead time. Employing a lead time feedback module to capture additional lead time variables, the SRMS offers this functionality. The variables measured and tracked by the lead time feedback module include: Supplier Raw Material Lead Time which is the amount of time that the supplier will need to order and receive any raw materials necessary for its' manufacturing process; Supplier Make Lead Time which is the amount of time that the supplier will need to manufacture the products; and Supplier Post Processing Lead Time which is the amount of time the supplier will need after manufacturing has completed in order to deliver the product.

In a further embodiment of the present invention, the SRMS traces the Schedule Item History by tracking and recording the history of each schedule item, including what documents, if any, created/changed the requirement and supplier actions. Although this information is available through the SRMS in a piecemeal fashion, a “Schedule Item Detail” screen retrieves, consolidates and displays the information for the user.

In an embodiment of the present invention, the SRMS also offers management level analysis tools that enable managers at the manufacturer to measure supply chain performance at an overall level. This includes tools such as: the ability for buyer/planners and administrators to view data for all items that have a common characteristic such as for a particular plant, product line, commodity code, etc.; a summary screen of supplier performance metrics for all suppliers; a summary screen of buyer/planner performance metrics for all buyer/planners; a summary screen of item trend performance metrics for all items; and a module for performing supplier profiling.

In a further embodiment of the present invention, the SRMS provides automation tools for automating a user's receiving functions, such as facilitating the recording of receipt of materials directly into the SRMS and integrating to existing manufacturer systems.

In a further embodiment of the present invention, the SRMS provides automation tools for automating supplier shipping functions, such as facilitating use of the SRMS to generate packing lists and other shipping-related documentation and integrating to existing supplier systems.

The embodiments described above are not intended to be limiting. One skilled in the art can appreciate the myriad of embodiment variations which fall within the scope of the invention as set forth.

We claim:

1. A system for normalizing at least one output data structure comprising:
a first server for receiving supply chain data in multiple data structures from multiple users;
a first application for extracting supply chain data from the multiple data structures;
a database for storing supply chain data in data fields within the database, wherein the supply chain data within the data fields is configurable by each of the multiple users according to the supply chain requirements of each of the multiple users;
a second server for retrieving from the database supply chain data from at least one of the data fields upon request from a requester, wherein the requestor is selected from the group consisting of at least one of the multiple users and at least one other user;
a second application for formatting the requested supply chain data into at least one output data structure;
a device for providing the requested supply chain data in the at least one output data structure, wherein the at least one output data structure is the same independent of the requestor, such that the at least one output data structure is normalized.

2. The system according to claim 1, wherein the multiple users are manufacturers.

3. The system according to claim 1, wherein the multiple users are a combination of manufacturers and suppliers.

4. The system according to claim 1, wherein the supply chain data includes at least one of the group consisting of product specification information, service specification information, quantity information, quality information, delivery information, and cost information.

5. The system according to claim 2, wherein the at least one other user is a supplier.

6. The system according to claim 1, wherein the supply chain data includes at least one of the group consisting of product description information, service description information, product availability information, service availability information, price information, and shipping information.

7. The system according to claim 1, wherein the multiple users are employees of a single manufacturer.

8. The system according to claim 7, wherein the at least one other user is a supplier.

9. The system according to claim 1, wherein the at least one output data structure is a display data structure.

10. The system according to claim 9, wherein the display data structure includes a search mechanism for searching the supply chain data displayed through the display data structure according to search criteria.

11. The system according to claim 10, wherein the search criteria include the identity of the multiple users and the at least one other user.

12. The system according to claim 9, wherein the display data structure is dynamically altered in response to at least one user input, wherein the at least one user input facilitates the manipulation of supply chain data.

13. The system according to claim 1, wherein the first server and the second server are the same server.

14. A system for normalizing at least one output data structure comprising:
means for receiving supply chain data in multiple data structures from multiple users;
means for extracting supply chain data from the multiple data structures;
means for storing supply chain data in data fields within a database, wherein the supply chain data is configurable by each of the multiple users according to the supply chain requirements of each of the multiple users;
means for retrieving from the database, supply chain data from at least one of the data fields upon request from a requester, wherein the requester is selected from the group consisting of at least one of the multiple users and at least one other user;
means for formatting the requested supply chain data into at least one output data structure;
means for providing the requested supply chain data in the at least one output data structure, wherein the at least one output data structure is the same independent of the requestor, such that the at least one output data structure is normalized.

15. A process for normalizing at least one output data structure comprising:
receiving supply chain data in multiple data structures from multiple users, wherein each of the multiple data structures is unique to one of the multiple users;
extracting the supply chain data from each of the multiple data structures;
comparing the extracted supply chain data to data fields within a database, wherein the supply chain data is configurable by each of the multiple users according to the supply chain requirements of each of the multiple users;
storing the extracted supply chain data in a matching data field within the database;
retrieving the extracted supply chain data from the matching data field, within the database, in response to a request to view the extracted supply chain data made by a requester, wherein the requestor is selected from the group consisting of at least one of the multiple users and at least one other user; and
providing the extracted supply chain data in at least one output data structure, wherein the at least one output data structure is the same regardless of the identity of the requester, such that the at least one output data structure is normalized for all requesters.

16. The process according to claim 15, wherein the supply chain data includes at least one of the group consisting of product requirements, service requirements, quantity requirements, quality requirements, delivery requirements, and cost requirements.

17. The process according to claim 15, wherein the multiple users are manufacturers.

18. The process according to claim 15, wherein the multiple users are a combination of manufacturers and suppliers.

19. The process according to claim 15, wherein the supply chain data includes at least one of the group consisting of product specification information, service specification information, quantity information, quality information, delivery information, and cost information.

20. The process according to claim 17, wherein the at least one other user is a supplier.

21. The process according to claim 15, wherein the multiple users are employees of a single manufacturer.

22. The process according to claim 21, wherein the at least one other user is a supplier.

23. The process according to claim 15, further comprising:
dynamically altering the output data structure in response to at least one user input, wherein the at least one user input facilitates the manipulation of supply chain data; and
providing the result of the manipulation of the output data structure in an altered output data structure.
